(19) United States
(12) Patent Application Publication
(10) Pub. No.: US 2026/0340080 A1
(43) Pub. Date: Oct. 29, 2026

(54) GENERATING NODE-SPECIFIC MACHINE LEARNING MODELS BY SELECTIVE CLUSTERING OF COLLECTED DATASETS

(71) Applicant: Dell Products L.P., Round Rock, TX (US)

(72) Inventors: Dora Boviz, Ottawa (CA); John Bradley Deforge, Chelsea (CA)

(21) Appl. No.: 19/190,265

(22) Filed: Apr. 25, 2025

(51) Int. Cl. G06F 18/2321; G06N 3/098

(52) U.S. Cl. CPC G06F 18/2321; G06N 3/098

(57) ABSTRACT

The technologies described herein are generally directed to generating node-specific machine learning models by selective clustering of collected datasets. For instance, a method can, based on a first metric value of a metric of network activity data of a first distributed node of network nodes of a network, and a second metric value of the metric of the network activity data of a second distributed node, identifying a clustering criterion applicable to cluster respective network activity data of the network nodes. The method may further include, based on the clustering criterion, clustering the respective network activity data, with the clustering criterion being selected from candidate clustering criteria based on at least one selection criterion. The method may further include, communicating to a machine learning training node, a training dataset applicable to train a machine learning model, with the training dataset being generated based on the clustered network activity data.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

An example method may include, based on a first metric value of a metric of network activity data of a first distributed node of network nodes of a network, and a second metric value of the metric of the network activity data of a second distributed node of the network nodes of the network, identifying at least one clustering criterion applicable to clustering respective network activity data respectively received from the network nodes of the network. The method may further include, based on the at least one clustering criterion, clustering the respective network activity data, resulting in clustered network activity data, with the at least one clustering criterion being selected from candidate clustering criteria based on at least one selection criterion. The method may further include, communicating to a machine learning training node, a training dataset applicable to train a machine learning model, with the training dataset being generated based on the clustered network activity data.

Additionally or alternatively, the at least one selection criterion is based on a performance threshold applicable to an estimated clustering performance level of the at least one clustering criterion selected from the candidate clustering criteria based on the estimated clustering performance level being determined to be at least at a level corresponding to the performance threshold. Additionally or alternatively, the network was organized in accordance with an open radio access network architecture. Additionally or alternatively, the performance threshold was received from a radio access network intelligent controller node included in the network. Additionally or alternatively, the estimated clustering performance level of the at least one clustering criterion was estimated by measuring the performance level of the at least one clustering criterion using a pre-defined labelled dataset.

Additionally or alternatively, the estimated clustering performance level of the at least one clustering criterion was estimated based on historical network activity data received from the network nodes of the network. Additionally or alternatively the method may further include, estimating, by the system, the estimated clustering performance level by predicting an average maximum performance level of the at least one clustering criterion applicable to respective usages of the at least one clustering criterion by the network nodes, resulting in a predicted average maximum performance level, and adjusting the predicted average maximum performance level based on a predicted overhead applicable to a quantity of the network nodes.

Additionally or alternatively the method may further include, determining, by the system, a first statistic and a second statistic, with the first statistic being determined based on the first metric value and the second statistic being determined based on the second metric value. Additionally or alternatively the identifying of the at least one clustering criterion may include identifying the at least one clustering criterion based on at least a defined threshold level of similarity that characterized the first statistic and the second statistic. Additionally or alternatively, the first statistic may include a statistical representation of raw data over a selected duration in time of the network activity data of the first distributed node.

Additionally or alternatively, the first metric may include at least one of a traffic load metric representative of a traffic load of first distributed node, a temperature metric representative of a temperature of the distributed node, a configuration metric representative of a hardware configuration of the distributed node, a quality metric representative of a channel quality indicator measured by the distributed node, a power metric representative of a radio frequency power of the distributed node, an emissions metric representative of an emissions of the distributed node, a consumption metric representative of an energy consumption of the distributed node, or an information metric representative of channel state information of a channel employed by the distributed node. Additionally or alternatively, the training dataset communicated to the machine learning training node may include metadata representative of at least one of first metadata representative of the at least one clustering criterion, second metadata representative of the at least one selection criterion, third metadata representative of the candidate clustering criteria, fourth metadata representative of the first distributed node, or fifth metadata representative of a characteristic of the first distributed node.

Additionally or alternatively, the metadata is applicable to selection, by a model repository node, of a target node for deployment of the machine learning model. Additionally or alternatively, the metadata is applicable to a period of time during which the machine learning model is prioritized for use over other machine learning models other than the machine learning model. Additionally or alternatively, the method may further include, before the at least one clustering criterion was selected, based on analysis of the candidate clustering criteria, identifying, by the system, a coverage gap potentially resulting from use of at least one analyzed candidate criterion of the candidate clustering criteria, different from the at least one clustering criterion. Additionally or alternatively, the method may further include, based on the coverage gap, removing, by the system, the at least one analyzed candidate criterion from the candidate clustering criteria.

Additionally or alternatively, the network was organized in accordance with an open radio access network architecture, and the distributed node may include a radio unit included in the network, and/or the machine learning training node may include a central unit of the network. Additionally or alternatively, the network activity data of the first distributed node was collected in accordance with a training specification of the machine learning model. Additionally or alternatively, the machine learning model was tailored to account for conditions and characteristics associated with the distributed node.

Example model repository equipment can operate as follows. At least one memory of the model repository equipment may store computer executable instructions, and at least one processor may be configured to process the computer executable instructions that, when executed by the at least one processor, facilitate performance of operations that include receiving a trained artificial intelligence-based model comprising auxiliary data representative of a characteristic of operating data that was processed to generate a training dataset with which the trained artificial intelligence-based model was trained, with the operating data being representative of a performance of base station equipment. The operations further include, based on a result of analyzing the auxiliary data, selecting a target distributed node. The operations further include communicating the trained artificial intelligence-based model to the target distributed node.

Additionally or alternatively, the selecting of the target distributed node was based on at least one of auxiliary data representative of a threshold level of similarity between the target distributed node and the base station equipment, and auxiliary data representative of the at least one clustering criterion applied to the target distributed node. Additionally or alternatively, the receiving of the trained artificial intelligence-based model may include receiving of the trained artificial intelligence-based model from model training equipment.

An example non-transitoxry machine-readable medium may include executable instructions that, when executed by at least one processor, facilitate performance of operations. The operations may include, based on an estimated performance metric of a first data grouping rule and a second data grouping rule, identifying the first data grouping rule as being applicable to grouping node-wise activity data of multiple radio unit devices of a radio access network, resulting in a selected grouping rule. The operations may further include, based on the selected grouping rule, grouping the node-wise activity data with a selected degree of similarity common to the multiple radio unit devices, resulting in grouped node-wise activity data. The operations may further include, based on the grouped node-wise activity data, generating a training dataset applicable to training a model of operation of the multiple radio unit devices.

Additionally or alternatively the operations may further include, based on the first data grouping rule and the selected degree of similarity, generating metadata applicable to facilitate inference operations of the model of operation by a radio unit node of the multiple radio unit devices. Additionally or alternatively, the training dataset may include the metadata. Additionally or alternatively, the metadata is further applicable to selecting, by a model repository device, the radio unit node of the multiple radio unit devices.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates a block diagram of a non-limiting example system that can facilitate generating node-specific machine learning models by selective clustering of collected datasets, in accordance with various aspects and embodiments of the disclosed subject matter;

FIG. 2 depicts a block diagram of a non-limiting example system that can include respective nodes to facilitate the selective generating and use of machine learning model variants at distributed nodes, in accordance with various aspects and embodiments of the disclosed subject matter;

FIG. 3 is a block diagram of a non-limiting example system, which can include respective nodes to facilitate the selective generating and use of machine learning model variants at distributed nodes, in accordance with various aspects and embodiments of the disclosed subject matter;

FIG. 4 is a block diagram of a non-limiting example system, which can include respective nodes to facilitate the selective generating and use of machine learning model variants at distributed nodes, in accordance with various aspects and embodiments of the disclosed subject matter;

FIG. 5 depicts a diagram of a non-limiting example AI component, in accordance with various aspects and embodiments of the disclosed subject matter;

FIG. 6 depicts a block diagram of a non-limiting example system that can comprise an O-RAN communication network environment to facilitate the generation and use of different node-specific machine learning model variants, in accordance with various aspects and embodiments of the disclosed subject matter;

FIG. 7 depicts a diagram of a non-limiting example base station that can desirably facilitate connections and communication of information associated with devices, in accordance with various aspects and embodiments of the disclosed subject matter;

FIG. 8 illustrates a diagram of a non-limiting example device that can be operable to engage in a system architecture that facilitates wireless communications according to one or more embodiments described herein;

FIG. 9 illustrates a non-limiting, an example system that can generate node-specific machine learning models by selective clustering of collected datasets, in accordance with one or more embodiments;

FIG. 10 depicts a flow chart illustrating elements of a system with machine learning model management, training and storage functions, in accordance with one or more embodiments;

FIG. 11 illustrates a flow chart of an example method that can desirably facilitate generating node-specific machine learning models by selective clustering of collected datasets, in accordance with various aspects and embodiments of the disclosed subject matter;

FIG. 12 depicts a flow chart of an example method that can desirably facilitate generating node-specific machine learning models by selective clustering of collected datasets, in accordance with various aspects and embodiments of the disclosed subject matter;

FIG. 13 depicts a flow chart of an example method that can desirably facilitate generating node-specific machine learning models by selective clustering of collected datasets, in accordance with various aspects and embodiments of the disclosed subject matter;

FIG. 14 illustrates an example block diagram of an example computing environment in which the various embodiments of the embodiments described herein can be implemented; and

FIG. 15 depicts a diagram of non-limiting example time series data of respective distributed nodes.

### DETAILED DESCRIPTION

Various aspects of the disclosed subject matter are now described with reference to the drawings, with like reference numerals being used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can facilitate generating node-specific machine learning models by selective clustering of collected datasets. Communication networks can enable users to use devices to wirelessly connect to a communication network and communicate with other devices (e.g., wireless devices or other communication devices). Communication networks also may employ AI-based technology to perform various tasks. For example, a communication network can employ an AI-based model to generate an inference or perform a task that can relate to operation of the communication network.

In some communication networks, there can be one or more RANs that each can include a group of distributed nodes that can perform various network-related functions. As an example, a distributed node can be a radio unit (RU) of a RAN (e.g., a disaggregated RAN). Existing techniques often can collect data relating to the distributed nodes and process such data centrally in the communication network.

For various types of applications, it can be desirable to utilize a model (e.g., an artificial intelligence (AI) or machine learning (ML) model) for inference and other desired purposes at the network edge of the communication network (or in other parts of the communication network). However, existing techniques can be deficient (e.g., inefficient, inaccurate, unsuitable, poor performing, suboptimal, or otherwise undesirable) in training AI or ML models and/or utilizing AI or ML models at the network edge of the communication network, and, accordingly, such AI or ML models can be deficient for use at the network edge of the communication network.

With further regard to the data associated with the distributed nodes, in networks with distributed nodes, while a relatively wide range of performance outcomes can be possible, each distributed node can be operating under different environmental and operational conditions. These conditions can determine a subset of overall potential performance outcomes at each node. Due to environmental and usage impacts, the behavior of components can evolve over time differently between different distributed nodes. Thus, data generated on each distributed node can, in some scenarios, differ from the data generated on other distributed nodes in the deployment. Accordingly, the data generated at each distributed node typically can differ between respective distributed nodes due in part to differences in data traffic load of the respective distributed nodes, differences in environmental conditions associated with respective distributed nodes, differences in configurations (e.g., node-specific hardware and/or software configurations) between the respective distributed nodes, and/or for other reasons. Different operational or environmental conditions can mean that it can be desirable to employ different optimization strategies. These different optimization strategies can be represented in distinct AI-based models. Data or datasets generated from each unique distributed node (e.g., each uniquely optimized distributed node) can exhibit statistically different characteristics from one another. Time series data generated by distributed nodes can be represented by a statistically unique segment of the data or dataset.

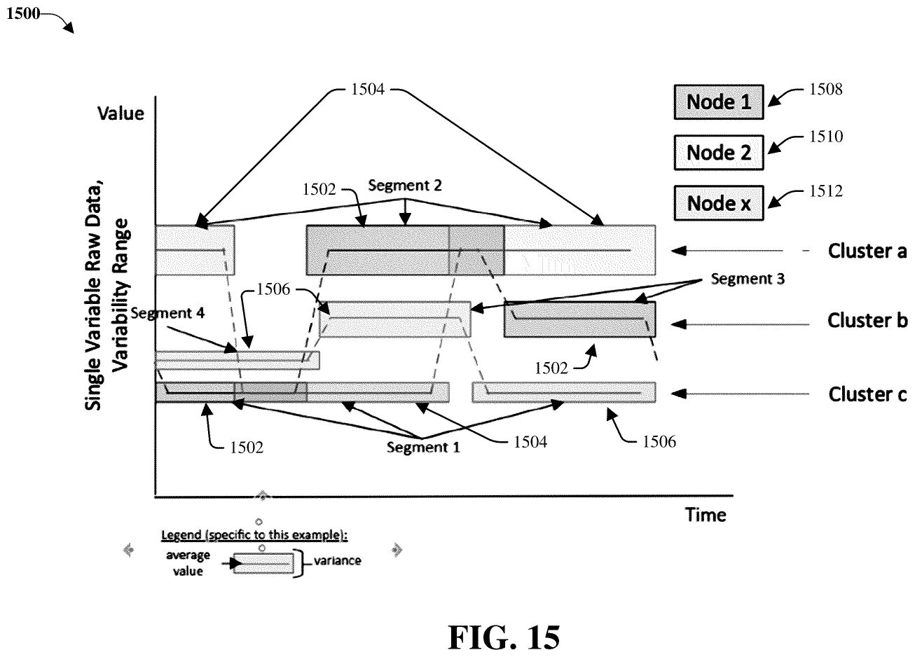

With further regard to time series data, the respective data collected from the respective distributed nodes can be time series data, with the time series data collected (e.g., centrally collected by the communication network) from each distributed node typically being a succession of segments be based on respective (e.g., independent or unique) conditions experienced by each distributed node of a deployment. These data segments can be the same for all or a subset of distributed nodes, can have similar properties or characteristics, or can result from significantly different operational scenarios. As a result, the distributed nodes can be said to have data variability, such as can be illustrated in FIG. 15. FIG. 15 is a chart of a non-limiting example time series data 1500 of respective distributed nodes, where there can be statistical characteristics of single-dimensional, single variable time series data with multiple data segments (although not limited to single-dimensional, single variable time series data). With regard to the data segments depicted in the time series data 1500, each of the time series data (e.g., time series data 1502, time series data 1504, and time series data 1506) can be generated in a different distributed node (e.g., node 1 1508, node 2 1510, and node x 1512, respectively). While for example purposes the time series data 1500 can be single dimensional and/or single variable time series data, time series data associated with distributed nodes also can be multi-dimensional and/or multi-variable time series data.

Collecting distributed data associated with the distributed nodes, bulk aggregating that data into a dataset, and creating a single AI or ML model for use in all distributed nodes, without accounting for the unique characteristics of each distributed node or specific segment, can lead to suboptimal performance of the model due to a deficient one-size-fits-all approach. Also, always using the same AI or ML model variant for each time series data and each distributed node can result in lower performance of the model due to the significant differences between data collected from different distributed nodes. It is noted that there may be instances where similar data segments can be present in data generated by different distributed nodes, where the same AI or ML model can be applicable though.

Further, it can be desirable to utilize AI-based models for inference execution and/or other AI-based analysis and output. In order to do so, it can be desirable to have AI-based models in each distributed node that can be suitable with respect to the locally observed conditions associated with that distributed node. To enable desirable (e.g., useful, enhanced, or optimal) use cases based on AI-based models with low latency specifications (e.g., requirements), the inference execution or other AI-based analysis potentially may be performed locally at the distributed nodes. However, due to practical product design of distributed nodes, the resources available at a distributed node for inference processing or other AI-based analysis can be undesirably limited. Therefore, it can be desirable for AI-based models to be sufficiently (e.g., highly) optimized in terms of resource usage. Such an approach can be said to be efficient where the AI-based models can be proportionally smaller with lower latency than a generic model applicable at all distributed nodes (e.g., where such an AI-based model can overcome the one-size-fits-all model inefficiencies). Unfortunately, existing systems, methods, and techniques for generating AI-based models can be deficient in generating AI-based models that can be desirable for the particularized use at a particular distributed node.

It can be desirable to address and overcome the aforementioned deficiencies and other deficiencies of existing systems and techniques for training and using AI or ML models. In that regard, the disclosed subject matter can provide enhanced techniques that can desirably (e.g., suitably, beneficially, advantageously, usefully, enhancedly, or optimally) address and overcome the aforementioned deficiencies and other deficiencies of the existing systems and techniques.

To that end, techniques that can desirably (e.g., automatically, dynamically, suitably, reliably, efficiently, enhancedly, and/or optimally) facilitate the creation of training datasets with deliberately narrower characteristic variance, e.g., each dataset of performance data collected by a distributed node may be highly granular and possessing a high degree of precision. In one or more embodiments, datasets generated may include both raw data and a statistical representation of the data generated by components of the distributed node.

In certain embodiments, the statistics (e.g., statistical data) can comprise or can relate to validation of the performance of each distributed node, and the measured performance, for each of the AI-based models, of the distributed node with respect to a desired outcome or target performance goal. In some embodiments, the statistics can relate to the variance in the data of the trained AI-based model among multiple distributed nodes. In still other embodiments, the statistics can involve taking the input data that can be obtained or collected by the distributed node 402 at a rate on the order of that of the symbol rate, and processing (e.g., by the pre-processing component 408 of the distributed node 402) the data to determine and generate statistical data that can be representative of the collected data, but desirably can be less complex data and/or a lower amount of data than the collected data, wherein the distributed node can transfer such statistical data to the central node (e.g., instead of communicating the higher amount of collected data). Such generation of statistical data, which can be less complex and/or a lower amount of data than the collected data, can be desirable and/or utilized, for example, when the verbose data (e.g., the larger amount of collected data) can be shown, over time, to be no better source for generating training data for model training than the statistical data representative of that same verbose data, without transferring all of that collected data off-node from the distributed node to the central node, which desirably can make the data curation and management less complex and less costly (e.g., less costly with regard to resource usage, time usage, and/or energy usage).

In accordance with various embodiments, the communication network can include one or more RANs (e.g., a disaggregated RAN(s)), wherein the central node can be part of or associated with a central unit (CU) of a RAN or a core network associated with (e.g., communicatively connected to) the RAN and part of the communication network. In accordance with various embodiments, respective distributed nodes can be, or can be part of or associated with, respective radio units (RUs) or respective distributed units (DUs) of the RAN, for each of the one or more RANs. The respective distributed nodes also can include or can be associated with respective distributed training nodes that can be, or can be part of or associated with, the respective RUs or the respective DUs of the RAN, for each of the one or more RANs. These and other aspects and embodiments of the disclosed subject matter will now be described with respect to the drawings.

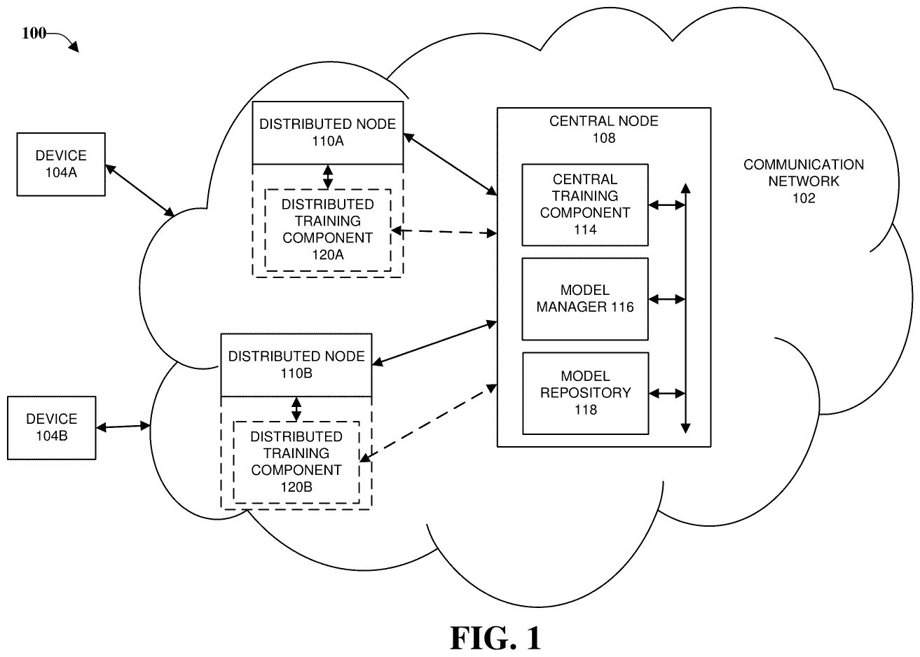

FIG. 1 illustrates a block diagram of a non-limiting example system 100 that can facilitate generating node-specific machine learning models by selective clustering of collected datasets, in accordance with various aspects and embodiments of the disclosed subject matter. For purposes of brevity, description of like elements and/or processes employed in other embodiments is omitted.

As depicted, system 100 includes communication network 102 that can enable wireless and wireline communication of information between devices, such as devices 104A-B, associated with (e.g., communicatively connected to) communication network 102, and/or between the device (e.g., devices 104A-B) and communication network 102. In some embodiments, communication network 102 can include a core network and one or more RANs, associated with the core network, that can enable the wireless communication of information between the devices 104A-B, the RAN, and the core network, such as described herein.

In certain embodiments, communication network 102 can include central node 108 and a group of distributed nodes, such as distributed nodes 110A-B that can be associated with (e.g., communicatively connected to) central node 108. In accordance with various embodiments, all or a portion of central node 108 can be part of the core network and/or the RAN (e.g., the CU or other component of the RAN), such as described herein. In accordance with various embodiments, all or a portion of distributed nodes 110A-B can be part of an RU or a DU of the RAN, such as described herein. In some embodiments, all or some of the respective distributed nodes 110A-B of the group of distributed nodes can be located (e.g., physically and/or logically located) at or near an edge (e.g., network edge) of communication network 102. It is to be appreciated and understood that, while various aspects and embodiments described herein can relate to cellular and wireless networks and communications, in certain embodiments, communication network 102 can be a communication network other than a cellular and/or wireless network, and the central node 108, the distributed nodes (e.g., 110A-B), and/or other components of the system 100 can be employed in such communication network 102.

In accordance with various embodiments, central node 108 can include central training component 114, model manager 116, and model repository 118. In some embodiments, central training node 114, model manager 116, and model repository 118 can be in the same central component 108. In certain other embodiments, central training component 114, model manager 116, and/or model repository 118 can be in separate central nodes that can be communicatively connected to each other, or can be part of separate portions of the central node 108, with the separate portions of central node 108 being communicatively connected to each other.

In some embodiments, central training component 114 can perform training of a model (e.g., an AI-based model), based at least in part on a training dataset, to generate a trained model relating to one or more of distributed nodes 110A-B. In embodiments, the training dataset can be derived from information relating to respective conditions and/or respective characteristics associated with respective distributed nodes 110A-B that can be received or collected by respective distributed nodes 110A-B with adaptive adjustment of collection parameters based on requirements of various AI-based models.

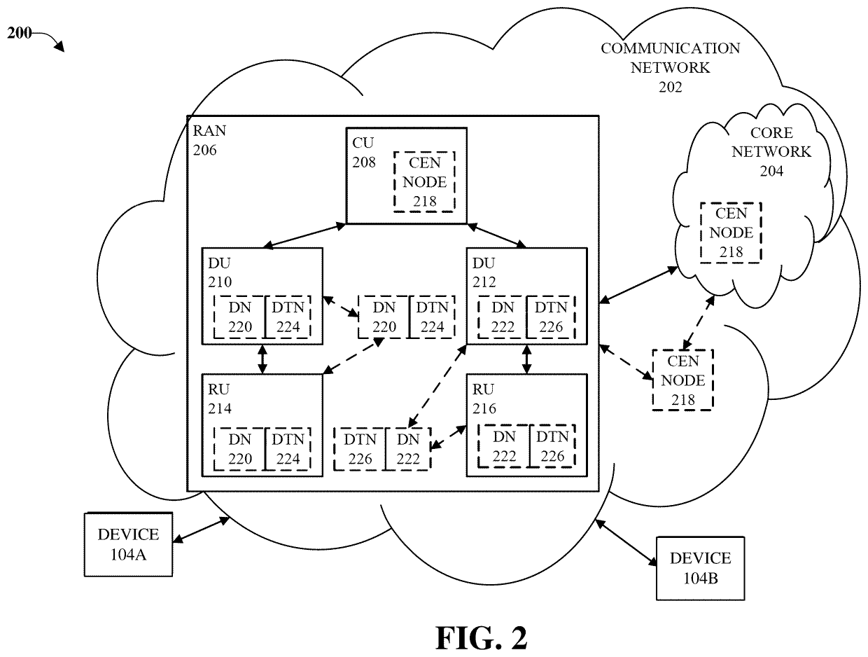

In accordance with various embodiments, respective distributed nodes 110A-B can include or can be associated with distributed training components 120A-B, which can additionally or alternatively perform training of an AI-based model, based at least in part on a training dataset generated based on performance data collected by distributed nodes 110A-B. In some embodiments, the group of distributed training components can include distributed training components 120A-B that can be part of, co-located with (e.g., physically co-located with), or associated with the distributed nodes 110A-B. In certain embodiments, one or more distributed training components can be instantiated for use in the system 100, as desired. In some embodiments, distributed training components 120A-B can share the same hardware and/or software resources with respective associated distributed nodes 110A-B, and, in other embodiments, as described with FIG. 2, a distributed training component can alternatively or additionally be termed a distributed training node, e.g., with the distributed training component/function being included in a node separate from the distributed nodes, and including separate hardware and/or software resources.

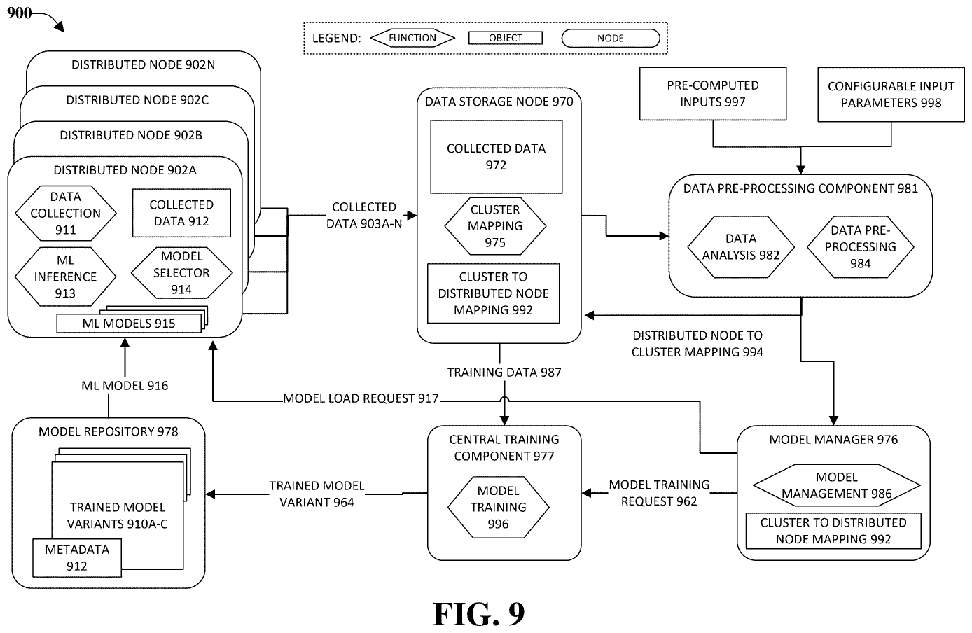

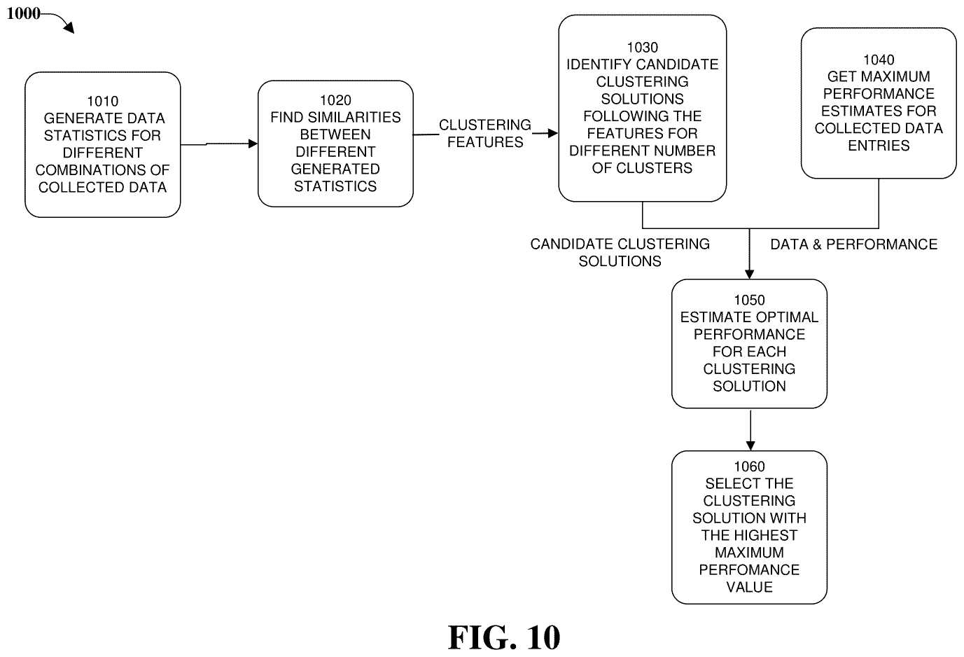

As described further with FIGS. 9-10 below, in one or more embodiments, model manager 116 may perform different management functions including, providing model training requests to the central training component 114, providing model selection configurations, providing model training requests for particular model variants, and model load requests for a selected model variant to be used for inferencing by a distributed node.

FIG. 2 depicts a block diagram of a non-limiting example system 200 that can include a RAN (e.g., a disaggregated RAN) that can include respective nodes to facilitate the selective generating and use of machine learning model variants at distributed nodes, in accordance with various aspects and embodiments of the disclosed subject matter. For purposes of brevity, description of like elements and/or processes employed in other embodiments is omitted.

As depicted, system 200 can include communication network 202 that includes core network 204 and one or more RANs, such as RAN 206, that can be associated with (e.g., communicatively connected to) core network 204. In embodiments, RAN 206 can include one or more base stations that can include one or more cells (not shown in FIG. 2).

In embodiments, core network 204, one or more RANs (e.g., RAN 206), the one or more base stations, and the one or more cells can facilitate (e.g., enable) wireless communication of data (e.g., voice or other audio data, video data, textual data, or other data) between devices (e.g., communication devices or UEs), such as devices associated with core network 204, via the one or more RANs, one or more base stations, and one or more cells, and other devices associated with core network 204 or, more generally, communication network 202 (e.g., a device, such as a server or computer, can be connected to communication network 202 via a wireline connection or via a network other than core network 204).

The devices can include, for example, devices 104A-B. In embodiments, devices 104A-B can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. Devices 104A-B can be associated with (e.g., communicatively connected to) communication network 202 via a communication connection and channel, which can include a wireless or wireline communication connection and channel.

In accordance with various embodiments, core network 204 can include various network components that can facilitate wireless communication of data. In some embodiments, RAN 206 can be a 5G or other NR RAN (e.g., gNB or xG RAN, wherein x can be a number greater than 5), and/or the base station(s) can be a 5G or other NR base station (e.g., gNB or xG base station). In some embodiments, RAN 206 can be an open RAN (O-RAN) that can be part of an O-RAN architecture and environment (e.g., communication network 202 can employ an O-RAN architecture and environment), such as described herein. In certain embodiments, core network 204 can include a user plane function (UPF) (also can be referred to as a UPF node), an application function (AF) (also can be referred to as an AF node), an application server, an access and mobility management function (AMF), and/or other network functions (not shown in FIG. 2 for reasons of brevity and clarity). The UPF can connect to or interface with the one or more RANs (e.g., RAN 206) and the one or more base stations, can be an interconnect point between core network 204 and a data network, can provide or facilitate providing a protocol data unit (PDU) session anchor point for providing mobility associated with radio access technologies (RATs), can provide or facilitate providing data packet routing or forwarding, and/or can perform or manage other functions.

The AF, which can be a control plane function, can be associated with, and can act as or fulfill all or part of the role of, the application server, and can interact and communicate with other network functions, including control plane functions, of core network 204. The AF and associated application server can facilitate (e.g., enable) provision of various services (e.g., voice services, messaging services, media streaming services, Internet and intranet services, multimedia conferencing and collaboration services, or other services) and applications to devices associated with core network 204. In some embodiments, some of the services can be low latency services and/or network edge services. The AF can include one or more AFs that respectively can be owned or managed by the network operator of core network 204 or by third parties (e.g., trusted third parties). In some embodiments, the UPF can be associated with, and can interact and communicate with, the AF and/or other network functions (e.g., other control plane functions) via a service-based interface (SBI).

The AMF node can be a control plane function that can manage registration and deregistration of devices 104A-B with core network 204, manage connections of devices with core network 204, manage mobility associated with devices (e.g., maintain knowledge of locations of devices, update locations of devices), and/or manage or perform other functions. In accordance with various other embodiments, the RAN(s) (e.g., RAN 206) and/or the base station(s) can include both 4^{th} generation (4G) long term evolution (LTE) technology and functions, and 5G or other NR-type or xG technology and functions.

Communication network 202, more generally, or core network 204 can include various other network equipment (e.g., routers, gateways, transceivers, switches, access points, network functions, processor components, data stores, or other devices or network nodes) that facilitate (e.g., enable) communication of information between respective items of network equipment of communication network 202, and/or communication of information between the one or more devices 104A-B and communication network 202. Communication network 202, including core network 204, can provide or facilitate wireless or wireline communication connections and channels between the one or more devices 104A-B, and/or respectively associated services or applications, and communication network 202. For reasons of brevity or clarity, some of the various network equipment, components, functions, or devices of the communication network may not be explicitly shown or described herein.

At various times, the respective devices 104A-B can utilize respective services or applications. The services or applications can include or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

In some embodiments, RAN 206 can be a disaggregated RAN that can include a CU 208, one or more DUs, such as DU 210 and/or DU 212, and one or more RUs, such as RU 214 and/or RU 216. CU 208 can be associated with the one or more DUs (e.g., 210 and/or 212), and the one or more respective DUs can be associated with the one or more respective RUs (e.g., 214 and/or 216). In certain embodiments, the DU (e.g., 210 or 212) can be located in a first location (e.g., geographical, physical, and/or logical location), CU 208 can be located in the first location or a second location, and the RU (e.g., 214 or 216) can be located in the first location, the second location, or a third location.

In accordance with various embodiments, all or respective portions of a central node (CEN NODE) 218 can be part of core network 204, CU 208, and/or another component (e.g., service management and orchestration (SMO) or RAN intelligent controller (RIC)) of communication network 202 (e.g., core network 204 can be or can include all or a portion of CEN NODE 218, and/or CU 208 can be or can include all or a portion of CEN NODE 218), or CEN NODE 218 can be a standalone component that can be associated with (e.g., communicatively connected to) core network 204 and/or CU 208. In accordance with various embodiments, all or respective portions of distributed node (DN) 220 can be part of RU 214, DU 210, and/or another component of communication network 202 (e.g., RU 214 can be or can include all or a portion of distributed node 220, and/or DU 210 can be or can include all or a portion of distributed node 220), or distributed node 220 can be a standalone component that can be associated with RU 214, DU 210, CEN NODE 218, and/or another component of communication network 202. Similarly, in accordance with various embodiments, all or respective portions of distributed node 222 can be part of RU 216, DU 212, and/or another component of communication network 202 (e.g., RU 216 can be or can include all or a portion of distributed node 222, and/or DU 212 can be or can include all or a portion of distributed node 222), or distributed node 222 can be a standalone component that can be associated with the RU 216, DU 212, CEN NODE 218, and/or another component of communication network 202.

In accordance with various embodiments, all or respective portions of distributed training node (DTN) 224 can be part of distributed node 220, and/or distributed training node 224 can be associated with (e.g., communicatively connected to) distributed node 220. Similarly, in accordance with various embodiments, all or respective portions of a distributed training node 226 can be part of distributed node 222, and/or the distributed training node 226 can be associated with (e.g., communicatively connected to) distributed node 222.

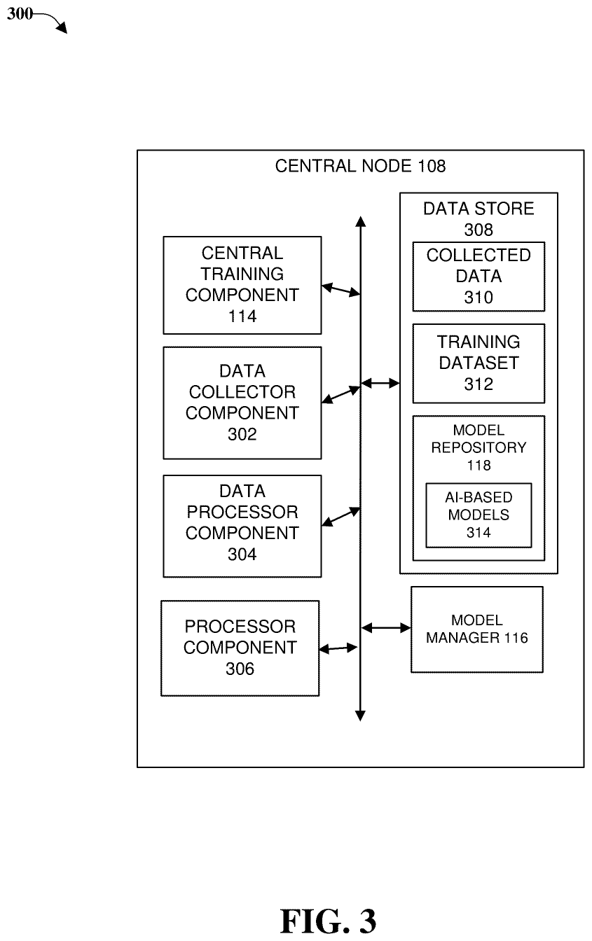

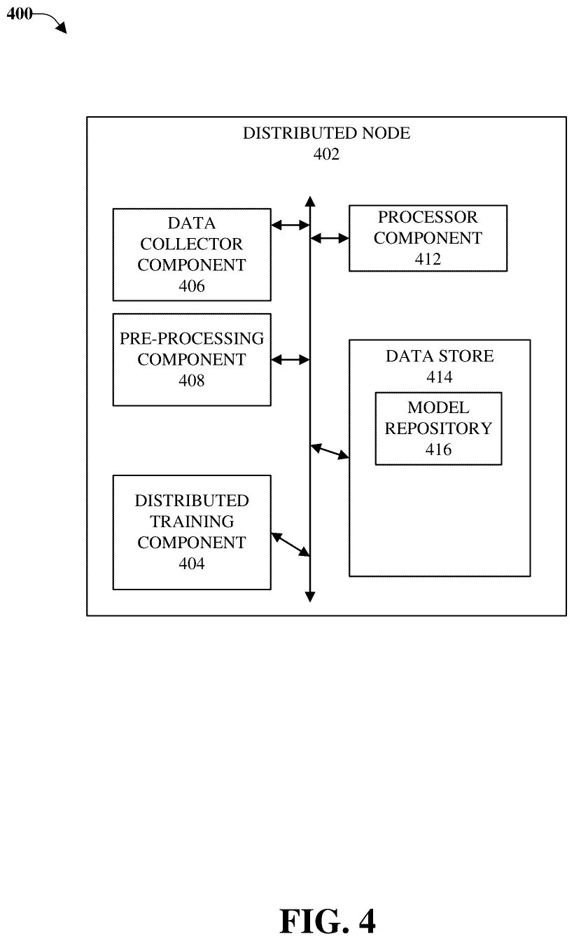

Referring to FIGS. 3 and 4, FIG. 3 is a block diagram of non-limiting example system 300, which can include central node 108, and FIG. 4 is a block diagram of a non-limiting example system 400, which can include distributed node 402, in accordance with various aspects and embodiments of the disclosed subject matter. For purposes of brevity, description of like elements and/or processes employed in other embodiments is omitted. In accordance with various embodiments, central node 108 can include central training component 114, data processor component 304, processor component 306, data collector component 302, and data store 308. In embodiments, central training component 114 can perform training of AI-based models, data store 308 can store various types of data relating to different functions of central node 108. The various types of data stored in data store 308 can include, for example, collected data 310 (e.g., distributed node-related data relating to respective conditions and/or respective characteristics associated with respective distributed nodes), training data 312 that can be utilized for training of AI-based models to generate trained AI-based models 314, which can be stored in model repository 118 of data store 308.

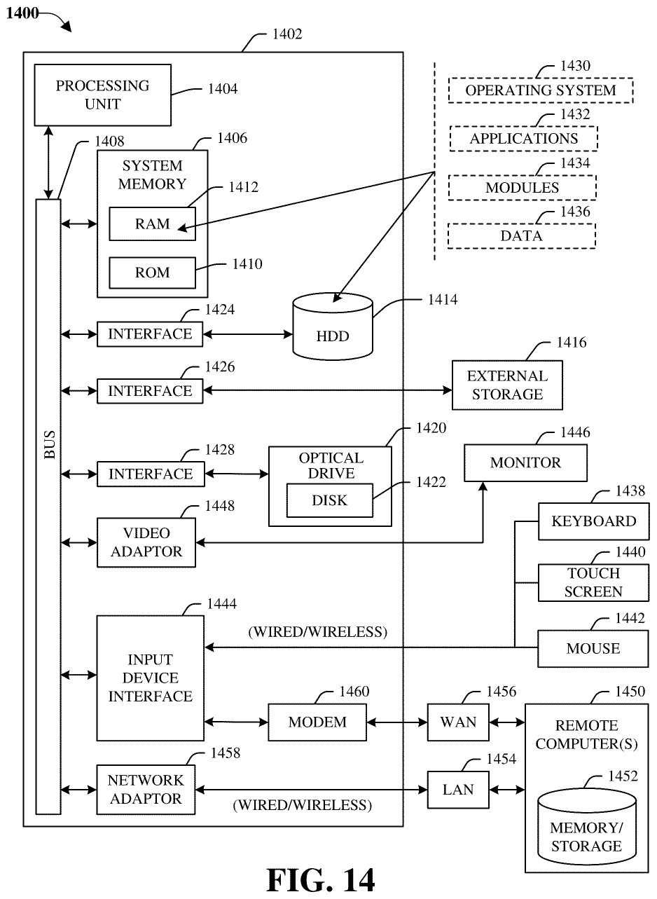

According to multiple embodiments, processor component 306 can comprise one or more processors and/or electronic circuitry that can implement one or more computer and/or machine readable, writable, and/or executable components and/or instructions that can be stored in data store 308. For example, processor component 306 can perform various operations that can be specified by such computer and/or machine readable, writable, and/or executable components and/or instructions including, but not limited to, logic, control, input/output (I/O), arithmetic, and/or the like. In some embodiments, processor component 306 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor component 306 are described below with reference to processing unit 1404 of FIG. 14. Such examples of processor component 306 can be employed to implement any aspect of embodiments of the subject disclosure.

In some embodiments, central training component 114 can perform training of AI-based models, and the data store 308 can store various types of data relating to the central node 108, distributed nodes 110A-B, and 402, distributed training components 120A-B, devices (e.g., device 104A-B), core network 204, and/or communication network 102. The various types of data stored in data store 308 can comprise, for example, collected data 310, such as distributed node-related data relating to respective conditions and/or respective characteristics associated with respective distributed nodes, statistical data (e.g., statistical data that can be derived from and/or representative of the distributed node-related data associated with the distributed nodes), other processed or derived data, metadata (e.g., parameters, hyperparameters, and/or other metadata), and/or other type(s) of data, training data 312 that can be utilized for training of AI-based models to generate trained AI-based models 314 (e.g., node-specific trained AI-based models), which can be stored in model repository 118 of the central node 108 along with model-related information (e.g., respective parameters, respective hyperparameters, and/or other respective metadata associated with the respective trained AI-based models 314). In accordance with various embodiments, some of the metadata can comprise descriptor information that can describe or identify respective characteristics of a trained AI-based model, model selection to facilitate determining (e.g., by a model selector component) whether to select an AI-based model for use by the distributed node, inference or other AI-based operations by the trained artificial intelligence-based model, and/or performance of other functions and/or operations, such as described herein. In some embodiments, model repository 118 (e.g., a data store utilized as the model repository) can comprise nonvolatile memory and/or volatile memory usable for storage of data, such as described herein.

In certain embodiments, distributed node 402 can be one distributed node of a group of distributed nodes that can be associated with central node 108 in communication network 102, e.g., distributed node 402 can be the same as or similar to the distributed nodes 110A-B, as depicted in FIG. 1. For clarity and brevity, only one distributed node 402 and one distributed training component 404 are illustrated in FIG. 4, and it is to be appreciated and understood that the group of distributed nodes can include virtually any desired number (e.g., 1, 2, 3, 4, 5, or other desired number greater than 5) of distributed nodes that can be associated with (e.g., communicatively connected to) central node 108, and correspondingly, the respective distributed nodes of the group of distributed nodes can be associated with respective distributed training nodes, which also can be associated with central node 108.

In accordance with various embodiments, distributed node 402 can include, for example, data collector component 406, pre-processing component 408 (e.g., a data processor that can analyze, filter, select, and/or otherwise process data), a processor component 412, a data store 414 including model repository 416 (which also can be referred to as a local model repository of the distributed node 402). In some embodiments, data store 414 may store various types of data relating to distributed node 402, distributed training component 404, devices (e.g., device 104A-B), the core network 204, and/or the communication network 102. The various types of data stored in the data store 414 can comprise, for example, data such as collected data (e.g., distributed node-related data relating to conditions and/or characteristics associated with the distributed node 402), the statistical data relating to the distributed node 402 and/or other distributed nodes, other processed or derived data, metadata, and/or other type(s) of data, data relating to AI-based models, and/or other desired data. The local model repository 416 can be employed to store AI-based models 420, such as trained AI-based models that can be particularly trained for use by the distributed node 402, and model-related information (e.g., respective parameters, respective hyperparameters, and/or other respective metadata associated with the respective trained AI-based models 420) relating thereto. In certain embodiments, the model repository 416 can comprise nonvolatile memory and/or volatile memory usable for storage of data, such as described herein.

In some embodiments, data store 414 may store various types of data relating to distributed node 402, the distributed training component 404, devices 104A-B, core network 204, and/or communication network 102. The various types of data stored in the data store 414 can include, for example, collected data (e.g., distributed node-related data relating to conditions and/or characteristics associated with distributed node 402), and trained AI-based models that can be particularly trained for use by distributed node 402.

In certain embodiments, the respective distributed nodes 110A-B, and/or 402 can receive and/or collect respective condition-related information relating to respective conditions associated with the respective distributed nodes. For instance, distributed node 402, employing data collector component 406, can receive and/or collect condition-related information from data collector component 302 relating to the conditions associated with distributed node 402, wherein the condition-related information can relate to respective conditions at respective times. The conditions can include, for example, operational conditions relating to operation of the distributed nodes 110A-B and/or 402, communication-related conditions associated with the distributed node, data traffic and processing load-related conditions, environmental conditions relating an environment associated with the distributed node, and/or other conditions associated with the distributed node or other network equipment or devices associated therewith. In some embodiments, the collected data (e.g., respective condition-related information and/or respective characteristics information) associated with respective distributed nodes can be or can include respective time series data (e.g., single dimensional and/or single variable time series data, and/or multi-dimensional and/or multi-variable time series data) comprising respective data segments, such as described herein.

In embodiments, distributed node 402 may use data collector component 406 to accumulate and store locally independent data (e.g., operating data such as traffic load, temperature, hardware configuration, etc.) and provide data to a node data select function of the distributed node. In embodiments, the collected data may be highly granular, e.g., in the context of a 5G network, the data may be as granular as a symbol—the smallest packet of data transmitted. Data collected and provided from distributed node 402 may include the node-wise performance data represented in both raw and statistical form over a given duration in time.

In example implementations, distributed node 402 may be an RU that collects local data. In another implementation, central node 108 may be a DU that collects performance data for multiple RUs. In embodiments, data collector component 406 may be hosted by central node 108 (e.g., data collector component 302) and have the capability to analyze the data collected by distributed node 402 and make modifications to the criteria used to collect data by distributed node 402.

In embodiments, data collector component 406 may be instantiated and communicatively coupled to both data pre-processing component 408 and/or multiple distributed nodes 402. In embodiments, data collector component 406, can be instantiated at distributed node 402 or off-node, e.g., at central node 108. In embodiments, data pre-processing component 408 may provide input regarding desired characteristics of node-wise data to data collector component 406, and the data collector component 406 may communicate optimization inputs to a node manager function of distributed node 402, e.g., changing data collection parameters to improve node-wise data collection distributed node 402. In embodiments, node-wise instantiation of pre-processing component 408 may be configured to pre-select key data collected on-node, and ready that data for export to data store 308. As described herein, key data may be broadly based on node-specific traffic load, environment, and operational conditions at selected distributed node of a network of nodes.

In embodiments performance/operating data collected by distributed node 402 can include, but is not limited to, independent environment data (e.g., traffic data, temperature, operational variables and values of configuration parameters), measurements (e.g., sensor data), and pre-existing on-node machine learning inferencing model outputs. In embodiments, operational functions within each node may be monitored by sensors active on each node to generate and provide node-dependent operational performance data (e.g., radio frequency (RF) power, distortion, emissions, energy consumption, and so on). Additionally, in embodiments, distributed node 402 may perform long term tracking of key CQIs such as; SNIR (in the case of the node being an RU), and channel sounding data derived from reference signals such as CSI-RS and SRS, e.g., channel sounding data processed into CQI at higher network levels and provided to each node for the purpose of improved inferencing outputs. Additionally or alternatively, node-specific configurations may be included with the performance data such as node-specific actuator configurations including, but not limited to, voltage bias configurations, signal gain, synthetic traffic injection, adaptive coefficients for performance improvement techniques (like CFR and DPD), and so on.

In one or more embodiments, collected datasets (e.g., raw data and statistical data) may be exported off-node, using, but not limited to, a suitable standard or an interim transport method that provides a format accessible to other vendors in a multi-vendor environment. In one embodiment the data transport method may be via log filed of the distributed node, and in another embodiment, data transport may be via an extensible ‘yet another next generation’ (YANG) models, in a third embodiment a new YANG model and/or a remote procedure call (RPC) definitions may be required in the network configuration protocol (NETCONF) server to request and supply specific data.

In one or more embodiments, distributed node 402 may compile statistical representations of raw data of a dataset collected over suitable durations (e.g., segments) of time corresponding to nodal operations. In one embodiment, a statistical representation of data may be used for improved processing efficiency at higher level processing functions, and in another embodiment, data may be used in conjunction with a data selection rubric for improved sorting into segments or clusters for model training purposes on the centralized data storage node.

The operational conditions can include or can relate to, for example, distortion, energy consumption, emissions, voltage bias (Vbias), component temperature, transmission power (e.g., radio frequency (RF)_power (P) output (RF_Pout)), crest factor reduction (CFR) coefficients or parameters, digital predistortion (DPD) coefficients or parameters, and/or other operational conditions associated with the distributed nodes 110A-B and/or 402. The operational conditions also can relate to the time periods associated with such operational conditions, such as, for example, the time of day, day of week, month of year, or other time period.

The conditions can include or can relate to, for example, signal-to-interference-plus-noise ratio (SINR), reference signal received power (RSRP), reference signal received quality (RSRQ), channel quality indicator (CQI), quality of service (QoS), perceived QoS, quality of experience (QoE) of a user, and/or other desired conditions, metrics, or parameters that can indicate the features or qualities of conditions associated with the distributed nodes 110A-B and/or 402 and/or devices 104A-B associated with the distributed node. In certain embodiments, the condition-related information also can include time data (e.g., timestamp or other time data that can indicate when a condition occurred or when an item of information relating to the condition was generated, event data (e.g., information relating to an event (e.g., sporting event, entertainment event, or other event where people using devices may gather) associated with a condition, such as an event that was taking place in proximity to the distributed node at the time the condition occurred), mapping data (e.g., mapping between a condition and another condition, mapping between a condition and a time of occurrence of the condition, mapping between a condition and an event, or other mapping relating to conditions), and/or other metadata relating to the conditions.

The environmental conditions can include or can relate to, for example, an environment associated with (e.g., in proximity to; or within a defined distance of) the distributed nodes 110A-B and/or 402. For instance, the environmental conditions can relate to whether the distributed node is located in a relatively populated or congested area (e.g., a metropolitan area that can have a relatively higher and/or more dense population of people who can use various devices) or a more rural area (e.g., an area having a relatively lower and/or less dense population of people), whether the distributed node is located near a hill or other environmental barrier in one or more directions (e.g., distributed node located in proximity to or within a defined distance of a relatively large hill located to the north of the distributed node), whether the distributed node is located in a business district (e.g., an area where there is a significant number of businesses that may have a relatively large number of people using devices during the business day on weekdays, but a relatively lower number of people using devices during evening or nighttime hours and/or during weekends) or non-business district (e.g., a residential area), and/or whether the distributed node is located near a venue(s) (e.g., a sports venue, a concert venue, an entertainment venue, or other venue) where a relatively large number of people using devices may gather for events. The environmental conditions also can relate to, for example, weather conditions (e.g., temperature, humidity, precipitation, air pressure, wind speed and direction, tornado, hurricane, flood, thunder, lightning, or other weather condition or event), climate conditions, electromagnetic interference, or other conditions that can have an effect on the operation of the distributed node.

In some embodiments, the respective distributed nodes 110A-B, and/or 402 also can have and/or can collect respective characteristics-related information relating to respective characteristics (e.g., attributes, features, or properties) of or associated with the respective distributed nodes. For instance, distributed node 402, employing data collector component 406, can have and/or can collect characteristics-related information relating to the characteristics of or associated with distributed node 402. The characteristics can relate to, for example, type(s) of cell(s) (e.g., sub-3 gigahertz (GHz) cell (e.g., sub-3 cell), and sub-6 GHz cell (e.g., sub-6 cell), millimeter wave (mmwave) cell, frequency division duplexing (FDD) cell, time division duplexing (TDD) cell, and/or other type of cell) of the distributed node, an accelerator function(s) (e.g., look-aside accelerator function, inline accelerator function, and/or other type of accelerator function) associated with the distributed node, an energy profile of the distributed node (e.g., use of energy by the distributed node in relation to (e.g., mapped to) conditions, time of day, day of week, event, and/or other factor), location of the distributed node, coverage area of the distributed node, and/or other characteristic, functionality, or feature of the distributed node. Some of the characteristics associated with the distributed node can relate to some conditions associated with the distributed node (e.g., an example characteristic can be that the distributed node can be located in an area where there can be a large hill located north of the distributed node, wherein such characteristic also can influence or can be a factor that can affect the conditions associated with the distributed node and can be an environmental condition and/or a communication-related condition associated with the distributed node). Distributed node 402 can store the condition-related information, characteristics information, and/or other information (e.g., as some of the data (e.g., collected data, statistical data, and/or other data) in the data store 414.

At various times, central node 108, employing the data collector component 302, can receive the respective condition-related information and/or the respective characteristics information from the respective distributed nodes 110A-B, and/or 402. For instance, the data collector component 302 can receive, obtain, and/or collect condition-related information and/or characteristics information from distributed node 402. In some embodiments, distributed node 402, employing pre-processor component 408, can process (e.g., pre-process) and/or filter items of condition-related information and/or characteristics information, and/or can derive (e.g., determine or calculate) other condition-related information and/or other characteristics information (e.g., summary information, alert or alarm information, highest value or lowest value associated with a condition, average, median, or other value associated with a condition, or other derived item of information) based at least in part on the results of analyzing the items (e.g., raw items) of condition-related information and/or characteristics information, and can communicate the processed (e.g., raw, processed, filtered, and/or derived) items of condition-related information and/or characteristics information to central node 108. In some embodiments, the data collector component 302 can store the respective condition-related information and/or the respective characteristics information associated with the respective distributed nodes (e.g., as the collected data 310) in data store 308.

In certain embodiments, distributed node 402, employing pre-processing component 408, can analyze the respective condition-related information and/or the respective characteristics collected by distributed node 402. As part of the analysis, pre-processing component 408 can determine (e.g., compute or otherwise determine) the statistical variables that can characterize the respective data received (e.g., imported, collected, or obtained) the respective distributed nodes. Pre-processing component 408 can determine such statistical variables, which can characterize the data, on a per distributed node basis, or on an aggregated basis from multiple or all of the distributed nodes, and/or in shorter or longer time durations. The statistical variables can be utilized as some of the various inputs that can be desired by the data pre-processing functions to facilitate preparing the data for use in the training (e.g., multi-stage training) of AI-based models and/or for other desired uses. In some embodiments, pre-processing component 408 can determine and/or generate statistics of a centralized aggregated dataset initially derived from data generated by distributed node 402, with these statistics representing the overall dataset and/or per-distributed node data, and can provide the metrics that can be desired (e.g., wanted or useful) to generate (e.g., create) training datasets for node-specific training stages for training of AI-based models.

In certain embodiments, based at least in part on the results of such analysis, pre-processing component 408 can process (e.g., pre-process), filter, segment, or select respective items of condition-related information and/or characteristics information associated with the respective distributed nodes to facilitate determining and generating one or more groups (e.g., datasets) of training data that can be utilized to facilitate training AI-based models. As part of the analysis, pre-processing component 408 can try to identify any similarities in the respective condition-related information and/or respective characteristics information associated with the respective distributed nodes. In some embodiments, pre-processing component 408 can perform such data processing based at least in part on predetermined (e.g., pre-computed) inputs (e.g., input parameters) and/or configurable input parameters, wherein the respective input and configurable parameters can be customized (e.g., tuned, enhanced, or optimized) for the generation of different training datasets.

In certain embodiments, the central node 108, employing data processor component 304, can analyze the respective condition-related information and/or the respective characteristics information associated with the respective distributed nodes (e.g., 110A-B, and 402). As part of the analysis, data processor component 304 can determine (e.g., compute or otherwise determine) the statistical variables that can characterize the respective data received (e.g., imported, collected, or obtained) the respective distributed nodes. Data processor component 304 can determine such statistical variables, which can characterize the data, on a per distributed node basis, or on an aggregated basis from multiple or all of the distributed nodes, and/or in shorter or longer time durations. The statistical variables can be utilized as some of the various inputs that can be desired by the data pre-processing functions to facilitate preparing the data for use in the training (e.g., multi-stage training) of AI-based models and/or for other desired uses. In some embodiments, the model manager node 116 (or data processor component 304 or other component) can determine and/or generate statistics of a centralized aggregated dataset initially derived from data generated by multiple distributed nodes (e.g., 110A-B), wherein these statistics can represent the overall dataset and/or per-distributed node data, and can provide the metrics that can be desired (e.g., wanted or useful) to generate (e.g., create) training datasets for joint (e.g., multi-node) and/or node-specific training stages for training of AI-based models.

Turning to a description that provides additional detail to the discussion of system 900 discussed below, in certain embodiments, based at least in part on the results of such analysis, data processor component 304 can process (e.g., pre-process), filter, segment, or select respective items of condition-related information and/or characteristics information associated with the respective distributed nodes to facilitate determining and generating one or more groups (e.g., datasets) of training data that can be utilized to facilitate training AI-based models. As part of the analysis, data processor component 304 can try to identify any similarities in the respective condition-related information and/or respective characteristics information associated with the respective distributed nodes. In some embodiments, data processor component 304 can perform such data processing based at least in part on predetermined (e.g., pre-computed) inputs (e.g., input parameters) and/or configurable input parameters, wherein the respective input and configurable parameters can be customized (e.g., tuned, enhanced, or optimized) for the generation of different training datasets.

For instance, based at least in part on first predetermined input parameters and/or first configurable input parameters, and based at least in part on the analysis results, data processor component 304 can process (e.g., pre-process), filter, segment, or select respective items of condition-related information and/or characteristics information associated with respective distributed nodes 110A-B to generate one or more clusters of training data (e.g., clusters, separated data) that can be utilized to facilitate training of one or more AI-based models. In some embodiments, the clusters of training data can be tailored or focused on similarities in the respective condition-related information and/or respective characteristics information associated with the respective distributed nodes, as identified (e.g., detected) by data processor component 304 based at least in part on the analysis results. In certain embodiments, in connection with generating the training data, data processor component 304 can execute data transformations and/or determine parameters relating to the training data, in accordance with the defined model management criteria, to achieve desired performance enhancement goals (e.g., optimization goals). Data processor component 304 can store the one or more respective clusters of training data (e.g., as the training data 312) in the data store 308 for use, if and when desired.

In some embodiments, the respective clusters of training data can relate to respective subgroups of conditions and/or respective subgroups of characteristics. For example, based at least in part on predetermined input parameters and/or the configurable input parameters, and based on the analysis results, data processor component 304 can process the data to generate one or more clusters of training data that can relate to operating conditions of the distributed units. For example, cluster of data may have been collected during conditions where the distributed nodes can be associated with a relatively high number (e.g., volume) of devices (e.g., distributed nodes near a busy business district where many users can be using devices), and another cluster of training data may relate to a different conditions where the distributed nodes collected data when relatively lower number of devices were being served, e.g., distributed nodes near a business district(s) at night or on weekends where a relatively lower number users can be using devices; or distributed nodes near a rural area where a relatively lower number users can be using devices.

In some embodiments, the central node 108, employing data processor component 304 and/or another component of the central node 108, can determine first parameters that can relate to and/or define the first threshold performance level, based at least in part on the results of analyzing the characteristics and/or statistics of the respective data (e.g., the respective condition-related information and/or the respective characteristics information) collected from the respective distributed nodes (e.g., 110 (or 402) and/or 112) of the group (e.g., cluster) of distributed nodes, wherein the first threshold performance level can be or can relate to (e.g., can correspond to or can be based at least in part on) the expected model precision that can be desired (e.g., wanted or needed) to be attained during the first stage model training (e.g., by the central training node 114). In certain embodiments, since the respective quality of the respective data collected from the respective distributed nodes can vary from distributed node to distributed node and/or over various times, data processor component 304 can determine (e.g., automatically determine) an input parameter(s) that can be utilized for (e.g., applied to) the threshold performance level determination (e.g., threshold computation) to define the respective weights (e.g., respective weight values) that can be attributed or applied to the respective statistical characteristics of the respective data collected from the respective distributed nodes, in accordance with the defined model management criteria. Accordingly, in certain embodiments, the central node 108, employing data processor component 304 and/or another component of the central node 108, can determine the first parameters that can relate to and/or define the first threshold performance level, based at least in part on the results of analyzing the characteristics and/or statistics of the respective data collected from the respective distributed nodes, as such characteristics and/or statistics of the respective data are respectively weighted based at least in part on the respective weights. Data processor component 304 can store information (e.g., parameters, hyperparameters, other metadata, and/or other information) relating to the first threshold performance level in the data store 308 and/or can provide such information to the model manager node 116, wherein the model manager node 116 can include such information in a model training request to enable the central training node 114 to determine, and/or apply the first threshold performance level and/or corresponding parameters during the model training stage of an AI-based model. It is noted that the first threshold performance level can be different at different times depending in part on various factors, including the quality of the collected data, the desired performance target for model training, the type of model, and/or another factor(s).

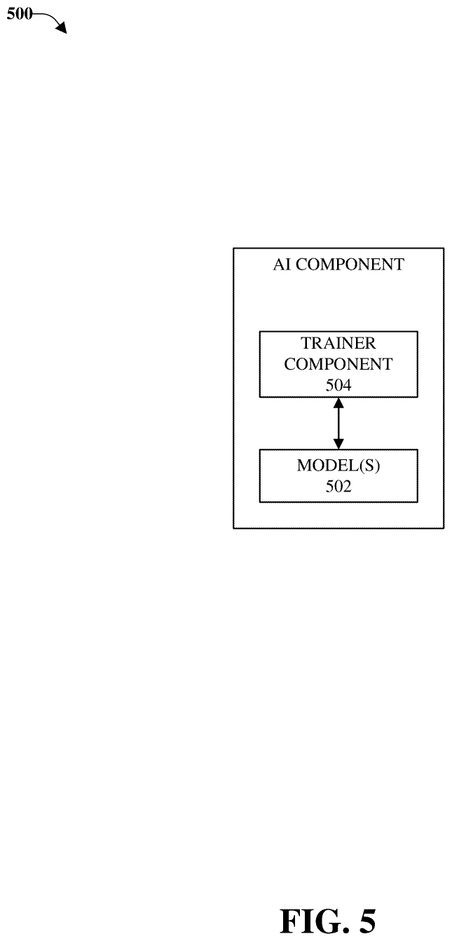

Referring to FIG. 5 (along with FIGS. 1-4), FIG. 5 depicts a diagram of a non-limiting example AI component 500, in accordance with various aspects and embodiments of the disclosed subject matter. In accordance with various embodiments, central training component 114 or a distributed training component 120A-B, and/or can be or can include an AI component, such as the AI component 500. In some embodiments, the AI component 500 and/or a model 502 (e.g., AI-based model) can perform an AI-based analysis on data, such as information relating to communication sessions, data traffic, applications, services, attributes, conditions, characteristics, operations, functions, parameters, events, and/or other features associated with the RAN and/or devices 104A-B, and/or core network 204, and/or feedback information (e.g., feedback information from a user, a device, a base station, network equipment or network function of core network 204, or another data source). In some embodiments, with regard to a model 502, the AI component 500 can input such information into the (trained) model 502 for analysis (e.g., AI-based analysis) by the model 502 to train or update the model 502 or to generate AI-based output result data based at least in part on the analysis of the input information.

In connection with or as part of such an AI-based analysis, the AI component 500 can employ, build (e.g., construct or create), and/or import, AI-based techniques and algorithms, AI-based models 502 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns of communication of data associated with applications, services, and/or devices, determining or learning about patterns of conditions and/or characteristics associated with a distributed node, determining or learning about patterns of respective conditions and/or respective characteristics associated with a group of distributed nodes, determining or learning about similarities or differences between respective conditions and/or respective characteristics associated with respective distributed nodes, determining or learning about data traffic associated with communication sessions between the RAN and devices 104A-B, performing other desired functions or operations, and/or automating one or more functions or features of the disclosed subject matter, as more fully described herein.

The AI component 500 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 500 can examine the entirety or a subset of the data (e.g., the training data; the operational data relating to communication network 102, core network 204, a device 104A-B, the RAN, a base station, one or more distributed nodes, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 500 and/or the trained model(s) 502 can employ one or more threshold probabilities (e.g., threshold probability values) to facilitate making a determination. For instance, in making a determination (e.g., a determination of whether a desired QoS associated with a device associated with a distributed node can be satisfied under certain conditions associated with the distributed node and/or the device, or other determination), as part of the AI-based analysis of information, the AI component 500 and/or the trained model(s) 502 can determine a probability (e.g., a probability that the desired QoS associated with the device can be satisfied under the certain conditions associated with the distributed node and/or the device, or other probability), and can determine whether the probability (e.g., probability value) satisfies (e.g., meets or exceeds; or is at or greater than) a defined and applicable threshold probability. The AI component 500 and/or the trained model(s) 502 can make a determination (or prediction or inference) (e.g., a determination (or prediction or inference) of whether to allocate more resources for the device to satisfy, or try to satisfy, the desired QoS associated with the device, or other determination) based at least in part on the results of analyzing (e.g., comparing) the probability to the defined and applicable threshold probability (e.g., threshold minimum probability value). As a non-limiting example, the AI component 500 and/or the trained model(s) 502 can make a determination (or prediction or inference) that allocating more resources for the device can satisfy the desired QoS associated with the device based at least in part on determining that a probability that allocating more resources for the device can satisfy the desired QoS associated with the device satisfies the defined and applicable threshold probability (e.g., the probability is the highest probability, relative to other probabilities relating to achieving the desired QoS associated with the device, and satisfies the defined and applicable threshold probability). In other embodiments, the AI component 500 and/or the trained model(s) 502 can make a determination (or prediction or inference) that allocating more resources for the device can satisfy the desired QoS associated with the device based at least in part on determining that a probability that allocating more resources for the device can satisfy the desired QoS associated with the device is a highest probability relative to the other probabilities, without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 500 can employ a classifier that can perform an AI-based analysis on data. A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 500 (e.g., employing the trainer component 504) can include, generate, and/or train (e.g., iteratively train) AI-based models 502 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., RAN, cells, distributed nodes, network nodes, communication links, devices, or other components or functions) of or associated with communication network 102; data traffic (e.g., type of data traffic, amount of data traffic, or other characteristic of data traffic) associated with communication sessions between the RAN and devices 104A-B (e.g., utilizing an application or service); patterns of communication of data associated with applications, services, and/or devices; patterns of conditions and/or characteristics associated with a distributed node; patterns of respective conditions and/or respective characteristics associated with a group of distributed nodes; similarities or differences between respective conditions and/or respective characteristics associated with respective distributed nodes; and/or patterns of data traffic associated with communication sessions between devices 104A-B and a distributed node, a group of distributed nodes, and/or the RAN; and/or to perform other desired functions or operations, and/or to automate one or more functions or features of the disclosed subject matter, as described herein.

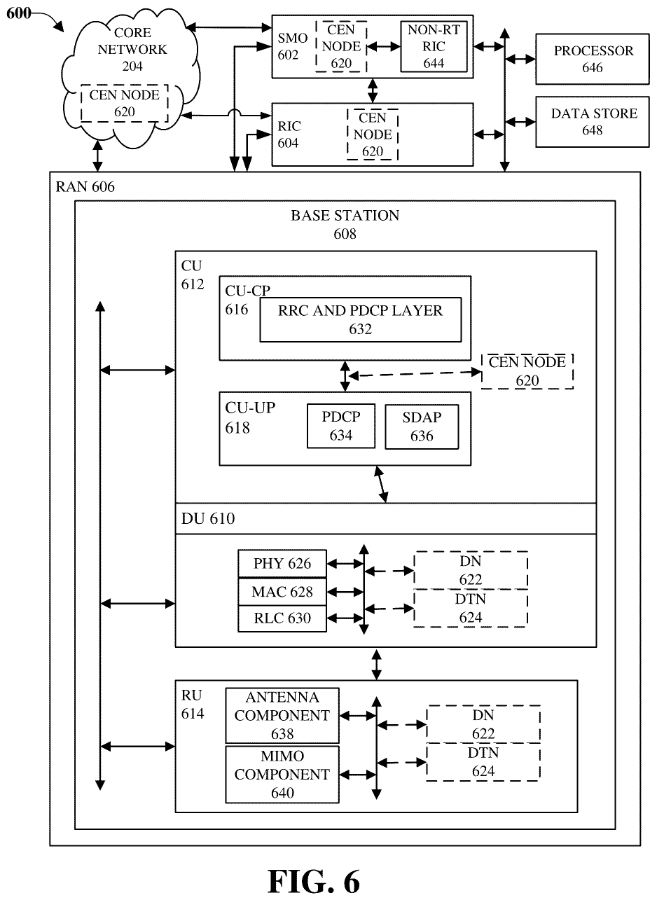

FIG. 6 depicts a block diagram of non-limiting example system 600 that can comprise the central node and the distributed training node(s) in the RAN in an O-RAN communication network environment to facilitate the generation and use of different node-specific machine learning model variants, in accordance with various aspects and embodiments of the disclosed subject matter. In some embodiments, the system 600 can be part of the system 100 depicted in FIG. 1 or the system 200 depicted in FIG. 2.

The system 600 can comprise an SMO 602, a RIC 604, and a RAN 606. In some embodiments, the RAN 606 can be an O-RAN that can be part of an O-RAN architecture and environment (e.g., the communication network 102 can employ an O-RAN architecture and environment). In certain embodiments, the RAN 606 can be deployed as a centralized or distributed RAN, and, in either of those cases, the RAN 606 can be instantiated on a cloud as a cloud-based RAN (C-RAN), or instantiated on a virtualized infrastructure as a virtual RAN (vRAN), wherein any of these scenarios and implementations may or may not be following O-RAN architecture and specifications. In still other embodiments, the RAN 606 may not be an O-RAN, C-RAN, or vRAN.

In accordance with various embodiments, the RAN 606 and associated communication network (e.g., communication network 102) can be part of a 5G or other communication environment (e.g., an xG communication environment, wherein x can be 5 or a number greater than 5). In some embodiments, with regard to 5G or other generation (e.g., xG), the RAN 606 can comprise base stations, such as a gNodeB (gNB), that can be disaggregated into a CU (e.g., gNB CU), comprising a CU-user plane (CU-UP) (e.g., gNB CU-UP), a CU-control plane (CU-CP) (e.g., gNB CU-CP), and a DU (e.g., gNB DU). In certain embodiments, the CU-UP and DU can perform various desired user plane functions, with the CU-UP hosting PDCP and SDAP functions, and the DU can host the RLC, MAC, and optionally, at least part of the PHY layers. For instance, the RAN 606 can comprise the base station 608 that can comprise a DU 610, a CU 612, and an RU 614 (e.g., a gNB RU). The CU 612 can comprise a CU-CP 616 (also referred to as a CU-CP node) and a CU-UP 618 (also referred to as a CU-UP node). In certain embodiments, the RAN 606 and/or the base station 608 can comprise multiple DUs, multiple CU-CPs, multiple CU-UPs, and/or multiple RUs. In some embodiments, the DU 610, the CU 612, and the RU 614 can be co-located at a cell site. In other embodiments, the RAN 606 can be a disaggregated RAN where one or more of the components (e.g., the CU 612, or at least part of the CU 612, such as the CU-CP 616) of the base station 608 can be located in different location than one or more other components (e.g., DU 610, RU 614, and/or CU-UP 618) of the base station 608.

In accordance with various embodiments, the system 600 can comprise a central node 620 that can be associated with (e.g., communicatively connected to or part of) the SMO 602, the RIC 604, and/or the CU 612, and/or can otherwise be part of or associated with the RAN 606, wherein the central node 620 can comprise various functionality and features, such as described herein. In accordance with various embodiments, the system 600 can comprise one or more distributed nodes, such as distributed node 622 that can be associated with (e.g., communicatively connected to or part of) the RU 614 and/or the DU 610, and/or can otherwise be part of the RAN 606, wherein the one or more distributed nodes (e.g., distributed node 622) can comprise various functionality and features, such as described herein. In accordance with various embodiments, the system 600 also can comprise one or more distributed training nodes, such as distributed training node 624 that can be associated with (e.g., communicatively connected to or part of) the distributed node 622, the RU 614, the DU 610, and/or the CU 612, and/or can otherwise be part of the RAN 606 and/or the central node 620, wherein the one or more distributed training nodes (e.g., distributed training node 624) can comprise various functionality and features, such as described herein. As a non-limiting example, one or more distributed training nodes, such as the distributed training node 624, can be logical distributed training nodes that can be physically or deployment-wise within the CU 612 or CU host, and can be mapped to specific RUs (e.g., RU 614 and/or another RU(s)) and/or DUs (e.g., DU 610 and/or another DU(s)).

The DU 610 can be a logical node that can host or handle baseband (e.g., physical layer (PHY) 626 (e.g., layer 1 (L1))) and layer 2 (L2) (e.g., a medium access control (MAC) layer 628 and a radio link control (RLC) layer 630) functionality associated with the base station 608. The CU-CP 616 can be a logical node that can host or handle layer 3 (L3) (e.g., a radio resource control (RRC) layer 632) control plane functionality associated with the base station 608. The CU-UP 618 can be a logical node that can host or handle data traffic between the core network 204 (e.g., 5G core network) and one or more DUs (e.g., the DU 610) to which the CU-UP 618 is connected. In some embodiments, the CU-UP 618 can comprise a packet data convergence protocol (PDCP) component (PDCP) 634 that can perform PDCP functions, and a service data adaptation protocol (SDAP) component (SDAP) 636 that can perform SDAP functions. In certain embodiments, the PDCP protocol can be utilized as part of the RRC layer 632 to process signaling bearers.

The RU 614 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 606 and other devices (e.g., devices 104A-B) or components (e.g., components or functions of the core network 204 or communication network 102). In certain embodiments, depending in part on the fronthaul split (e.g., the division of fronthaul-related functions) utilized, some higher PHY layer functions also can be included and employed in the RU 614. In some embodiments, the RU 614 can comprise an antenna component 638 that can comprise an antenna array that can comprise a desired number of transmitter and receiver antennas to facilitate transmission and receiving of signals comprising information, and perform various beamforming, antenna-related, and communication-related functions. The RU 614 also can comprise a MIMO component 640 that can be employed to generate or modify a number of MIMO spatial layers and a number of spatial streams employed by the base station 608 (e.g., with regard to a device(s)) during a communication session between the base station 608 and a device (e.g., device 104), and may perform MIMO spatial multiplexing functions. In certain embodiments, the MIMO component 640 can be configured in a single user (SU)-type MIMO mode or a multiple user (MU)-type MIMO mode. In some embodiments, the MIMO component 640 can employ or support massive MIMO (mMIMO). The RU 614 also can comprise or be associated with other components 642 that can utilize and/or perform various other RU and RF functions. Some other functions that can be employed by the antenna component 638, the MIMO component 640, and/or the other components 642 can include, for example, modulation and coding scheme (MCS) functions, transmit diversity functions, beamforming functions (e.g., utilized with MIMO functions), and/or other functions.

In some embodiments, as disclosed, the system 600 can comprise an O-RAN architecture and environment, and the RAN 606 can be an O-RAN. In some embodiments, in the O-RAN architecture and environment, the SMO component 602 can be associated with (e.g., communicatively connected to) the RIC 604 and/or the RAN 606 (and/or one or more other RANs) via an interface(s) (e.g., an O1 interface, an A1 interface, or another interface), to facilitate communication of information between the SMO component 602 and the RIC 604 and/or the RAN 606 (and/or one or more other RANs), and the RIC 604 can be associated with the RAN 606 (and/or one or more other RANs) via an interface(s) (e.g., an E2 interface or another interface), to facilitate communication of information between the RIC 604 and the RAN 606 (and/or one or more other RANs). In some embodiments, the SMO component 602 can comprise a non-real time RIC 644 (NON-RT RIC) that can perform some RAN intelligent controller functions in non-real time. In certain embodiments, the RIC 604 can be or can comprise a near real time RIC that can perform at least some of the various RAN intelligent controller functions in real time or at least near real time.

The SMO component 602 can act and operate as a management and orchestration layer that can control configuration and automation aspects of the RIC 604 and RAN elements of the RAN(s) 606. The SMO component 602 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 604 can operate to control (e.g., manage) and enhance (e.g., improve or optimize) RAN functions and services of the RAN(s) 606. As disclosed, at least some of the various network functions and components of the RIC 604 can operate in real time or near real time, whereas certain other network functions and components of the non-real time RIC 644 may operate in non-real time.

In accordance with various embodiments, the system 600 can comprise a processor component 646 that can be associated with (e.g., communicatively connected to) and can work in conjunction with other components of the system 600, including the SMO component 602, the RIC 604, the RAN 606, the central node 620, the distributed node 622, the distributed training node 624, a data store 648, and/or other components of the system 600, to facilitate performing the various functions and operations of the system 600. The processor component 646 can employ one or more processors (e.g., one or more central processing units (CPUs)), accelerators, graphics processing units (GPUs), application-specific integrated circuits (ASICs), microprocessors, controllers, microcontrollers, or other processors) that can process information relating to data, files, services, applications, RANs, base stations, cells, communication network, core network, devices, users, data traffic, communication sessions (e.g., PDU or other communication sessions), uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate operation of the system 600, and control data flow between the system 600 and/or other components (e.g., network equipment, components, or functions, the communication network 102, the core network 204, another base station, a device (e.g., 104A-B), a node, an application, a service, a user, or other entity) associated with the system 600.

The data store 648 can store data structures (e.g., user data, metadata), code structure(s) (e.g., modules, objects, hashes, classes, procedures) or instructions, information relating to data, files, services, applications, RANs, base stations, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate controlling or performing operations associated with the system 600. The data store 648 can comprise volatile and/or non-volatile memory, such as described herein. In an aspect, the processor component 646 can be functionally coupled (e.g., through a memory bus) to the data store 648 in order to store and retrieve information desired to operate and/or confer functionality, at least in part, to the SMO component 602, the RIC 604, the RAN 606, the central node 620, the distributed node 622, the distributed training node 624, the processor component 646, the data store 648, and/or other component of the system 600, and/or substantially any other operational aspects of system 600.

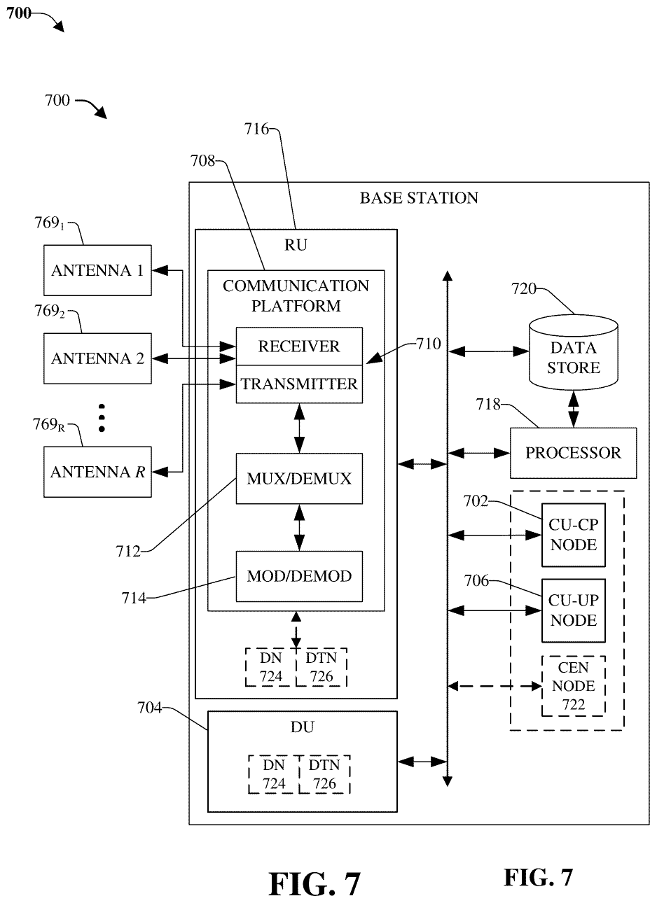

Turning to FIG. 7, FIG. 7 depicts a diagram of a non-limiting example base station 700 that can desirably facilitate (e.g., enable) connections (e.g., wireless connections) and communication of information associated with devices, in accordance with various aspects and embodiments of the disclosed subject matter. In some embodiments, the base station 700 can be a 5G or other radio base station (e.g., gNB or xG base station, wherein x can be a number greater than 5). In other embodiments, the base station 700 can be a 4G or LTE base station, can be a base station that can comprise 5G or other xG functionality and 4G/LTE functionality, or can be some other type of base station (e.g., other type of access point).

With regard to a 5G or other radio base station, the base station 700 can comprise a CU-CP node 702 (e.g., a gNB CU-CP node), one or more DUs (e.g., a gNB DUs), including DU 704, a desired number of CU-UP nodes (e.g., a gNB CU-UP nodes), including CU-UP node 706, and/or other network equipment. The CU-CP node 702 can be associated or interfaced with the DUs (e.g., DU 704) via an interface (e.g., F1-C interface) or connection. The CU-CP node 702 can be associated, or interfaced, with the CU-UP nodes (e.g., CU-UP node 706) via an interface (e.g., E1 interface) or connection. The one or more CU-UP nodes (e.g., CU-UP node 706) can be associated or interfaced with the one or more DUs (e.g., DU 704) via an interface (e.g., F1-U interface) or connection.

A DU (e.g., DU 704) can provide support for lower layers of a protocol stack. For instance, a DU (e.g., DU 704) can be a logical node that can host or handle baseband (e.g., PHY) and L2 (e.g., MAC and RLC layer) functionality associated with the base station 700. A CU-UP node (e.g., CU-UP node 706) can be a logical node that can host or handle data traffic between the core network 204 (e.g., 5G or xG core network) and the DU(s) (e.g., DU 704) to which the particular CU-UP is connected. The CU-CP node 702 can be a logical node that can host or handle L3 (e.g., RRC and PDCP layer) control plane functionality associated with the base station 700.

In some embodiments, a device(s) (e.g., device(s) 110 and/or 112) can be connected to the base station 700, via the DU 704, wherein the CU-UP node 706 and the DU 704 can be serving the device by performing or facilitating performing downlink data transfers of downlink data to the device from a data source (e.g., a service and/or another device, or a network component of the communication network 102 or core network 204 (e.g., via the UPF node)), and uplink data transfers of uplink data from the device to a desired destination (e.g., the data source) via the base station 700.

The base station 700 can receive and transmit signal(s) from and to wireless devices like access points (e.g., base stations, femtocells, picocells, or other type of access point), access terminals (e.g., UEs), wireless ports and routers, and the like, through a set of antennas 769₁-769_{R}. In an aspect, the antennas 769₁-769_{R} can be a part of a communication platform 708, which comprises electronic components and associated circuitry that can provide for processing and manipulation of received signal(s) and signal(s) to be transmitted. In an aspect, the communication platform 708 can include a receiver/transmitter 710 that can convert signal from analog to digital upon reception, and from digital to analog upon transmission. In addition, receiver/transmitter 710 can divide a single data stream into multiple, parallel data streams, or perform the reciprocal operation.

In an aspect, coupled to receiver/transmitter 710 can be a multiplexer/demultiplexer (mux/demux) 712 that can facilitate manipulation of signal in time and frequency space. The mux/demux 712 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 712 can scramble and spread information (e.g., codes) according to substantially any code known in the art, e.g., Hadamard-Walsh codes, Baker codes, Kasami codes, polyphase codes, and so on. A modulator/demodulator (mod/demod) 714 also can be part of the communication platform 708, and can modulate information according to multiple modulation techniques, such as frequency modulation, amplitude modulation (e.g., M-ary quadrature amplitude modulation (QAM), with M a positive integer), phase-shift keying (PSK), and the like. In accordance with various embodiments, the communication platform 708 can be, can comprise, or can be associated with an RU 716 (e.g., a gNB RU node).

The base station 700 also can comprise a processor(s) 718 that can be configured to confer and/or facilitate providing functionality, at least partially, to substantially any electronic component in or associated with the base station 700. For instance, the processor(s) 718 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 700 can include a data store 720 that can store data structures; code instructions; rate coding information; information relating to measurement of radio link quality or reception of information related thereto; information relating to devices, communication conditions or performance indicators associated with devices (e.g., SINR, RSRP, RSRQ, CQI, QoS, perceived QoS, QoE, and/or other wireless communications metrics or parameters) associated with devices; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 718 can employ one or more processors (e.g., one or more CPUs, accelerators, GPUs, ASICs, or other processors), microprocessors, or controllers) that can process information, and can be coupled to the data store 720 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information) desired to operate and/or confer functionality to the communication platform 708 and/or other operational components of the base station 700. The data store 720 can comprise volatile memory and/or nonvolatile memory, such as described herein.

In accordance with various embodiments, the base station 700 can comprise a central node 722 that can be part of or can be associated with (e.g., can be deployed and/or instantiated on the same physical or logical computing infrastructure as or of) the CU (e.g., CU comprising CU-CP node 702 and CU-UP node 706) and/or other components of the RAN, and/or can otherwise be part of or associated with the base station 700, wherein the central node 722 can comprise various functionality and features, such as described herein. In accordance with various embodiments, the base station 700 also can comprise a distributed node 724 and a distributed training node 726 that can be part of or can be associated with the RU 716, the DU 704, and/or other components of the base station 700, and/or can otherwise be part of or associated with the base station 700, wherein the distributed node 724 and the distributed training node 726 can respectively comprise various functionality and features, such as described herein.

With further regard to the data stores and memory disclosed herein, the data store (e.g., 644 or 720) or memory can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects is intended to comprise, without being limited to, these and other suitable types of memory.

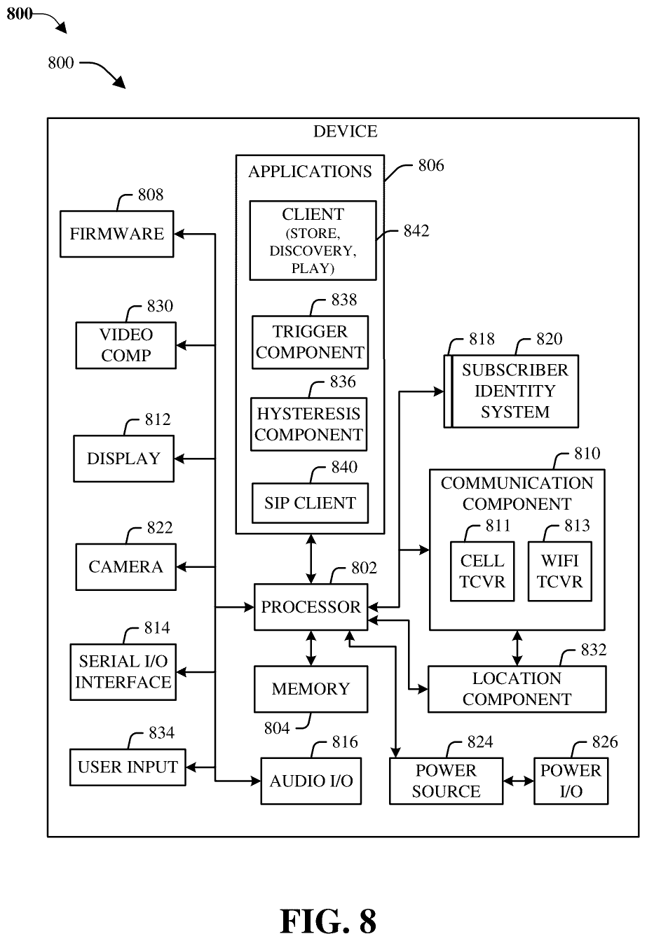

Referring to FIG. 8, FIG. 8 illustrates a diagram of a non-limiting example device 800 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein.

Although a device is illustrated herein, it will be understood that other devices can be a communication device, and that the device 800 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 800, can typically include a variety of machine-readable media. Machine-readable media can be any available media that can be accessed by the computer and include both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 800 can include a processor(s) 802 for controlling and processing all onboard operations and functions. The processor(s) 802 can comprise one or more processors (e.g., one or more CPUs, accelerators, GPUs, ASICs, or other processors), microprocessors, or controllers) that can process information associated with the device 800. A memory 804 can interface to the processor(s) 802 for storage of data and one or more applications 806 (e.g., a video player software, user feedback component software, or other application). Other applications can include voice recognition of predetermined voice commands that facilitate initiation of the user feedback signals. Still other applications can comprise an AI application. The applications 806 can be stored in the memory 804 and/or in a firmware 808, and executed by the processor(s) 802 from either or both the memory 804 and/or the firmware 808. The firmware 808 can also store startup code for execution in initializing the device 800. A communication component 810 interfaces to the processor(s) 802 to facilitate wired/wireless communication with external systems, e.g., cellular networks, VoIP networks, and so on. Here, the communication component 810 can also include a suitable cellular transceiver 811 (e.g., a global system for mobile communication (GSM), orthogonal frequency division multiple access (OFDMA), 4G, LTE, 5G, other xG, or other type of transceiver) and/or an unlicensed transceiver 813 (e.g., Wi-Fi, WiMax) for corresponding signal communications. The device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, etc.). The display 812 can also display videos and can facilitate the generation, editing and sharing of video quotes. A serial I/O interface 814 is provided in communication with the processor(s) 802 to facilitate wired and/or wireless serial communications (e.g., USB, and/or IEEE 1394) through a hardwire connection, and other serial input devices (e.g., a keyboard, keypad, and mouse). This supports updating and troubleshooting the device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The device 800 can include a slot interface 818 for accommodating a SIC (Subscriber Identity Component) in the form factor of a card Subscriber Identity Module (SIM) or universal SIM 820, and interfacing the SIM card 820 with the processor(s) 802. However, it is to be appreciated that the SIM card 820 can be manufactured into the device 800, and updated by downloading data and software.

The device 800 can process IP data traffic through the communication component 810 to accommodate IP traffic from an IP network such as, for example, the Internet, a corporate intranet, a home network, a person area network, etc., through an ISP or broadband cable provider. Thus, VoIP traffic can be utilized by the device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The device 800 also includes a power source 824 in the form of batteries and/or an AC power subsystem, which power source 824 can interface to an external power system or charging equipment (not shown) by a power I/O component 826.

The device 800 can also include a video component 830 for processing video content received and for recording and transmitting video content. For example, the video component 830 can facilitate the generation, editing and sharing of video quotes. A location tracking component 832 facilitates geographically locating the device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the device 800 to support SIP protocols and register the subscriber with the SIP registrar server. The applications 806 can also include a client 842 that provides at least the capability of discovery, play and storage of multimedia content, for example, music.

The device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., device 800). The device 800 can accommodate at least satellite radio services through a device (e.g., handset device) that can combine wireless voice and digital radio chipsets into a single device (e.g., single handheld device).

It is to be appreciated and understood that one or more components (e.g., the devices, configuration manager component, base station, core network, or other component) of the systems (e.g., system 100, system 400, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

FIGS. 9-10 illustrate non-limiting, example systems 900 and 1000 that can employ data pre-processing to generate node-specific machine learning models by selective clustering of collected datasets, in accordance with one or more embodiments. For purposes of brevity, description of like elements and/or processes employed in other embodiments is omitted.

System 900 includes distributed nodes 902A-N, data storage node 970, data pre-processing component 981, model manager 976, central training component 977, and model repository 978. In embodiments, model manager 976 and central training component 977 may have similar characteristics as model manager 116 and central training component 114 described above with FIGS. 1-3, and the functions of model manager 116 and central training component 114 may also be performed by model manager 976 and central training component 977, respectively.

Ones of distributed nodes 902A-N may have characteristics described with reference to distributed nodes 110A-B and 402 discussed above. Example distributed node 902A includes data collection function 911, machine learning inference function 913, collected data object 912, model selector function 914, and machine learning models 915. Data storage node 970 receives collected data 903A-N from distributed nodes 902A-N, respectively, and stores the collected data as collected data object 972. Data storage node 970 further includes cluster mapping function 975.

Data pre-processing component 981 receives pre-computed inputs 997 and input parameters 998, provides distributed node to cluster mapping 994 to data storage node 970, and includes data analysis function 982 and data pre-processing function 984. In embodiments, data pre-processing component 981 may have similar characteristics as data processing component 304 above, and the functions of data processing component 304 described above may also be performed by data pre-processing component 981.

Model manager 976 stores distributed node to cluster mapping 994 received from data pre-processing component as cluster to distributed node mapping object 992. Central training component 977 includes model training function 996, receives training data 987 from data storage node 970 and model training request 962 from model manager 976, and provides trained model variant 964 to model repository 978. Model repository 978 provides machine learning model 916 to distributed node 902A based on model load request 917 from model manager 976, and stores trained model variant 964 as trained model variant object 910, with metadata 912 included therewith.

In embodiments of system 900, data may be collected from distributed nodes 902A-N, stored at data storage node 970, and processed by data pre-processing component 981, resulting in training data 987 being used by central training component 977 to train one or more machine learning models 915. In the next section, different functions of data pre-processing component 981 are discussed in the context of processing collected data 903A-N to generate training data 987, and trained model variant 910 with metadata 912 advantageously describing different aspects of the pre-processing performed.

In certain embodiments, data pre-processing component 981, can receive collected data 972 (including one or more of individual and/or aggregated data from distributed nodes 902A-N) analyze the respective condition-related information and/or the respective characteristics information associated with activity of respective distributed nodes 902A-N. In embodiments, data collected by system 900 from the distributed nodes may include, but are not limited to, a traffic load metric representative of a traffic load of first distributed node, a temperature metric representative of a temperature of the distributed node, a configuration metric representative of a hardware configuration of the distributed node, a quality metric representative of a channel quality indicator measured by the distributed node, a power metric representative of a radio frequency power of the distributed node, an emissions metric representative of an emissions of the distributed node, a consumption metric representative of an energy consumption of the distributed node, and/or an information metric representative of channel state information of a channel employed by the distributed node.

In embodiments, data pre-processing component 981 can determine (e.g., compute or otherwise determine) statistical variables that can characterize the respective data received (e.g., imported, collected, or obtained) from the respective distributed nodes. Data pre-processing component 981 can determine such statistical variables, which can include a statistical representation of raw data, on a per distributed node basis, or on an aggregated basis, from multiple or all of the distributed nodes, over a selected duration in time. With respect to system 900, statistical variables generated by data pre-processing component 981 (or model manager node 976, or other component) can determine and/or generate statistics of an aggregated dataset initially derived from data generated by multiple distributed nodes 902A-N, with these statistics representing the overall dataset and/or per-distributed node data.

Generally speaking, the generated statistical variables may be used by embodiments to facilitate clustering (e.g., grouping, separating, cluster mapping) collected data 903A-N for use in generating training data 987 and metadata 912. FIG. 10 depicts a flow diagram of the different elements of this pre-processing described below. In embodiments, metadata 912 (depicted as providing auxiliary data to trained model variants 910A-N, may have been attached to trained model variants 910A-N at the time of training by central training component 977, e.g., from metadata attached to training data 987 by data pre-processing component 981 during the clustering process described below.

Turning to FIG. 10 and an example operation in system 900 of data pre-processing component 981, at 1010, data statistics may be generated for different combinations of collected data 972, e.g., data statistics generated for data collected from respective nodes 902A-B. To facilitate generating training data from the collected data, data pre-processing function 984 of data pre-processing component 981 may be configured by different elements of system 900. In an example implementation, training datasets generated by one or more embodiments may be generated to have a lesser variance between data of a particular parameter (also termed ‘metric’ herein). For example, data pre-processing component 981 may receive configurable input parameters 998 which may provide input data or instructions, including pre-defined optimization goals discussed with 1020 below. In embodiments, configurable input parameters 998 may be received from a RIC of communication network 202 organized as an O-RAN system.

At 1020, similarities may be identified between different generated statistics (e.g., of data from different nodes), by using data analysis function 982 to identify data having at least a threshold level of similarity. In embodiments, based on similarities detected by data analysis function 982, data pre-processing function 984 may determine different criteria that may be used to separate the collected data into multiple subsets so that training data generated therefrom may yield machine learning models 915 with increased model performance as compared to training datasets generated by non-clustered data. In some embodiments, the characteristics selected to be evaluated (e.g., by data analysis function 982) for clustering of collected data 972 may be selected based on fitting a pre-defined performance threshold goal (e.g., also termed optimization in an example where a maximum performance is estimated/predicted). One or more embodiments, to increase the likelihood that clustering criteria selected will be the best/optimal clustering criteria, may apply relevant external inputs directly to data preprocessing function 984 to estimate the performance of different candidate options for clustering collected data 972. Continuing the discussion of data pre-processing component 981 being configured by different elements of system 900, in embodiments, data pre-processing component 981 may receive a pre-defined performance threshold goal via configurable input parameters 998.

At 1030, embodiments may generate two or more candidate clustering solutions that follow features for different number of resulting clusters. In some implementations different approaches may be used to generate a list of possible clustering solutions (e.g., candidate clustering criteria) based on the characteristics of the aggregated dataset. Based on different network characteristics, different clustering solutions may differ between network deployments. In embodiments, based on the generation of the list of possible clustering solutions being potentially compute intensive, this list generation may be limited to being performed when changing data statistics indicate that the clustering approach may need to be updated.

At 1040, maximum performance estimates may be generated for a machine learning model trained by collected data that was clustered using respective candidate clustering criteria. One or more embodiments may estimate the maximum performance that can be theoretically achieved by a distributed unit that uses a machine learning model that was trained using the candidate clustering criteria determined by 1030 described above. In one approach, this estimate may be generated by using a supervised learning approach, e.g., using a pre-defined labelled dataset to project the maximum performance from collected data entries. Continuing the discussion of data pre-processing component 981 being configured by different elements of system 900, data pre-processing component 981 may receive a pre-defined labelled dataset via pre-computed inputs 997.

It should be noted that, in some embodiments described herein, the “maximum” performance is used here as an estimation of the expected best performance of the model, with the actual performance expected to be lower, e.g., based on the data transformation at model training being potentially less than optimal suboptimal as a result of inclusion of the natural variance of the selected dataset for clustering.

At 1050, for comparison of clustering solutions, optimal performance for each clustering solution may be estimated. For example, for the candidate clustering options identified by 1030 above, an average expected maximum performance (e.g., a sum of average performance per cluster/number of clusters) may be determined. In embodiments, this performance result may be adjusted by a weight based on the total number of clusters predicted to be generated by the clustering option, e.g., thereby accounting for potential extra compute overhead due to more separate training tasks.

At 1060, the clustering solution with the highest average expected maximum performance value may be selected for clustering the collected data. In embodiments, exception handling procedures may specify that, when the average expected maximum performance of the best option is lower than an acceptable model performance threshold, the underlying data statistics may be updated, and the candidate selection process starting at 1030 may be re-executed with the updated statistics.

The following section discusses another aspect of embodiments that may improve the likelihood that training datasets generated using clustered data provide useful results. In one or more embodiments, clustering of training datasets may be advantageously generated to provide full coverage of the possible parameter space. In some implementations, initially selected clustering approaches may result in clustered training datasets with parameter-wise coverage holes. As additional data is provided from the use of deployed systems, clustering and training datasets may naturally evolve to be more specific and provide more complete coverage of parameters, while meeting minimum performance objectives through retraining and refinement. Additionally or alternatively, in an implementation where coverage holes are identified at a relatively early phase, a default operational mode for embodiments we default to setting where an estimated maximum performance would be a goal, e.g., without weighting the efficiency of the settings, e.g., in recognition that machine learning data has not been developed fully at the deployment, settings could be used that facilitate collecting training data.

For example, in an implementation, before the clustering criterion is selected, based on analysis of the candidate clustering criteria, embodiments may identify a coverage gap potentially resulting from use of at least one analyzed candidate criterion of the candidate clustering criteria. Based on the coverage gap, embodiments may remove the analyzed candidate criterion from the candidate clustering criteria.

Turning to an additional element of system 900 discussed with FIGS. 9-10, as noted above, in one or more embodiments, system 900 includes model repository 978. In embodiments, model repository 978 may have similar characteristics as model repository 118 described above, and the functions of model repository 118 described above may also be performed by model repository 978. In embodiments, model repository 978 may be instantiated on the same or different compute and storage infrastructure as central node 108 and/or model manager 976.

In one or more embodiments, model repository 978 (also termed “model catalog” herein) may receive and store trained model variants 910A-N, e.g., from central training component 977. Additionally, model repository 978 may, based on different factors, manage the transfer of one or more machine learning data sets to selected distributed nodes 902A-N. For example, in one or more embodiments, model load request 917 may be communicated to distributed nodes 902A-N and/or model repository 978 via an interface to model manager 976.

Another factor that may be used by model repository 978 to allocate trained model variants 910A-C to distributed nodes 902A-N includes metadata 912 attached to one or more of trained model variants 910A-C. As noted above, in embodiments, metadata 912 may have been attached to trained model variants 910A-N at the time of training by central training component 977 based on the training and metadata attached to training data 987 by data pre-processing component 981 during the clustering process described below, e.g., such metadata describing clustering criteria, and the like, which may be useful to determine which of distributed nodes 902A-N may be usefully allocated to receive trained model variants 910A-C.

Stated differently, in embodiments, model repository 978 may coordinate the results of data pre-processing described above, with other data processing steps on a per cluster basis, with the resulting artifacts (e.g., metadata, auxiliary data) being added to a stored data entity. Further to this end, an embodiment of model repository 978 may utilize indexes and/or filters to manage the machine learning model catalog.

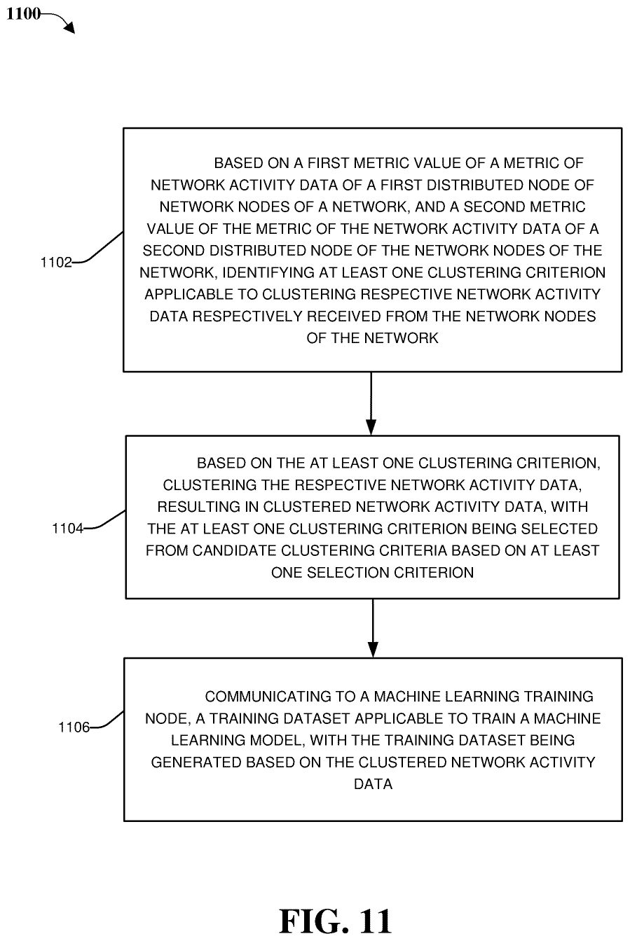

FIG. 11 depicts a flow diagram representing example operations of an example method 1100 that can facilitate generating node-specific machine learning models by selective clustering of collected datasets, in accordance with one or more embodiments. For purposes of brevity, description of like elements and/or processes employed in other embodiments is omitted.

FIG. 11, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 1102, method 1100 includes, based on a first metric value of a metric of network activity data of a first distributed node of network nodes of a network, and a second metric value of the metric of the network activity data of a second distributed node of the network nodes of the network, identifying at least one clustering criterion applicable to clustering respective network activity data respectively received from the network nodes of the network. For example, one or more embodiments of data pre-processing component 981 of central node 108 may, based on a traffic load value of a traffic load metric representative of a traffic load of distributed node 902A and traffic load value of a traffic load metric representative of a traffic load of distributed node 902B, identify at least one clustering criterion applicable to clustering respective traffic load values received from distributed nodes 902A-B. An example clustering criterion includes a similarity of traffic loads collected during business hours and weekend hours, by distributed nodes 902A-B.

At 1104, method 1100 includes, based on the at least one clustering criterion, clustering the respective network activity data, resulting in clustered network activity data, with the at least one clustering criterion being selected from candidate clustering criteria based on at least one selection criterion. For example, one or more embodiments of data pre-processing component 981 may, based on the at least traffic load value clustering criterion, cluster the respective traffic load values, resulting in clustered network activity data, with the traffic load value clustering criterion being selected from candidate clustering criteria based on the traffic load value selection criterion.

At 1106, method 1100 includes communicating to a machine learning training node, a training dataset applicable to train a machine learning model, with the training dataset being generated based on the clustered network activity data. For example, one or more embodiments of data pre-processing component 981 may communicate directly (or via data storage node 970) to central training component 977, training dataset 987 applicable to train a machine learning model by model training function 996, with the training dataset being generated based on the clustered network activity data.

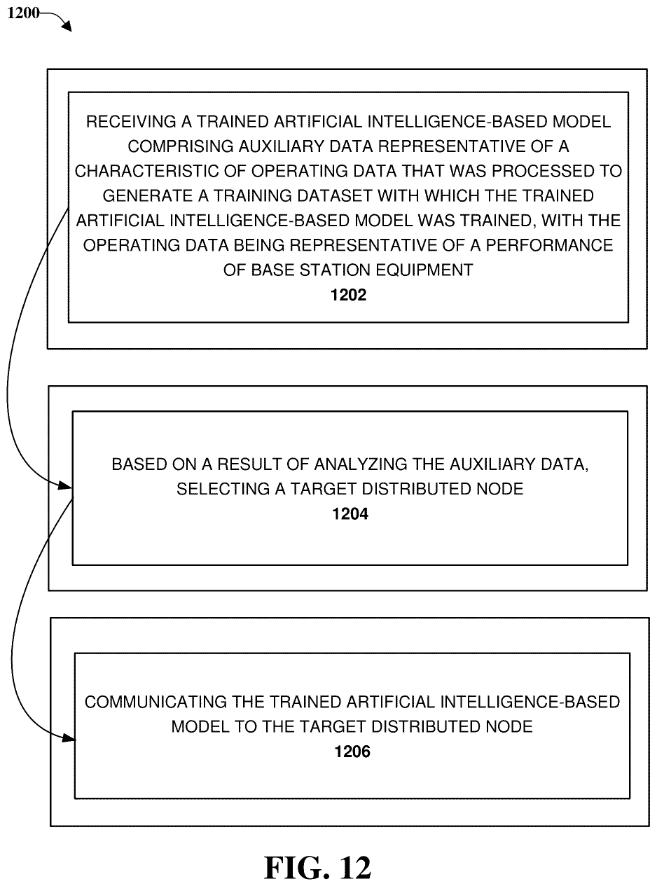

FIG. 12 depicts a flow diagram of an example system 1200 that can facilitate generating node-specific machine learning models by selective clustering of collected datasets, in accordance with one or more embodiments. For purposes of brevity, description of like elements and/or processes employed in other embodiments is omitted. System 1200 includes at least one memory that stores computer executable components, and at least one processor that executes the computer executable components stored in the at least one memory, as described herein, in accordance with one or more embodiments.

At 1202 of FIG. 12, computer executable instructions are included that facilitate performance of operations that include receiving a trained artificial intelligence-based model comprising auxiliary data representative of a characteristic of operating data that was processed to generate a training dataset with which the trained artificial intelligence-based model was trained, with the operating data being representative of a performance of base station equipment. For example, one or more embodiments of model repository 978 can receive trained model variant 964 (stored as trained model variant 910A) including metadata 912 representative of a traffic load value of a traffic load metric that was processed to generate training dataset 987 with which the trained model variant 910A was trained, with the operating data being representative of a traffic load of distributed nodes 902A-N.

At 1204 of FIG. 12, computer executable instructions are included that facilitate performance of operations that include, based on a result of analyzing the auxiliary data, selecting a target distributed node. For example, one or more embodiments can, based on a result of analyzing the metadata 912, select distributed node 902A.

At 1206 of FIG. 12, computer executable instructions are included that facilitate performance of operations that include communicating the trained artificial intelligence-based model to the target distributed node. For example, one or more embodiments can communicate trained model variant 910A to distributed node 902A.

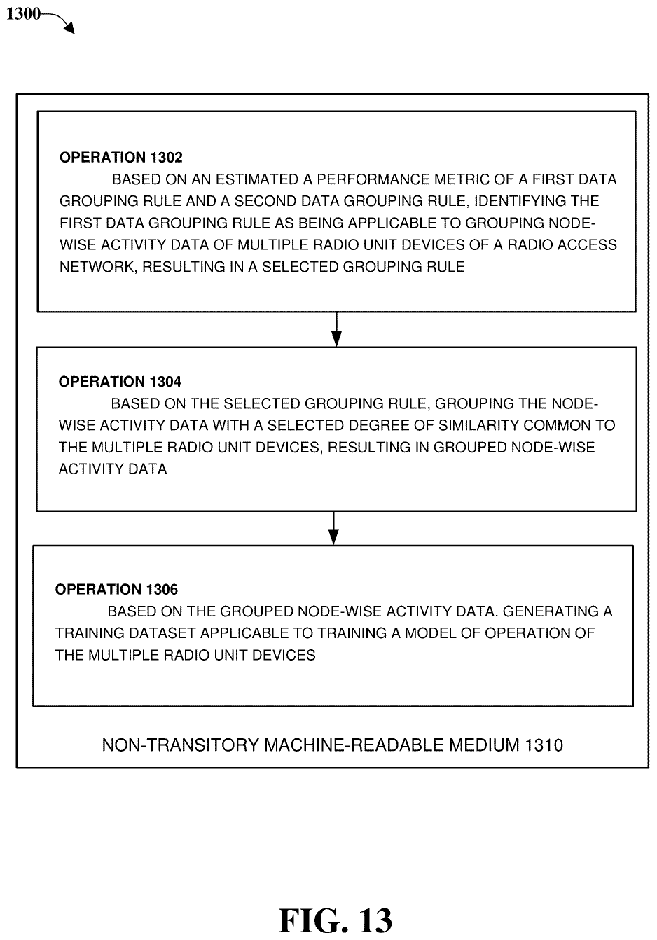

FIG. 13 depicts an example 1300 non-transitory machine-readable medium 1310 that can include executable instructions that, when executed by a processor of a system, can facilitate generating node-specific machine learning models by selective clustering of collected datasets, in accordance with one or more embodiments. For purposes of brevity, description of like elements and/or processes employed in other embodiments is omitted.

As depicted, non-transitory machine-readable medium 1310 includes executable instructions that, when executed by at least one processor of a machine learning device, facilitate performance of operations that include operation 1302 which can, based on an estimated performance metric of a first data grouping rule and a second data grouping rule, identify the first data grouping rule as being applicable to grouping node-wise activity data of multiple radio unit devices of a radio access network, resulting in a selected grouping rule. The operations may further include operation 1304 which can, based on the selected grouping rule, group the node-wise activity data with a selected degree of similarity common to the multiple radio unit devices, resulting in grouped node-wise activity data. The operations may further include operation 1304 which can, based on the grouped node-wise activity data, generate a training dataset applicable to training a model of operation of the multiple radio unit devices.

In order to provide additional context for various embodiments described herein, FIG. 14 and the following discussion are intended to provide a brief, general description of a suitable computing environment 1400 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 also can be configured for external use in a suitable chassis (not shown). Additionally, while not shown in environment 1400, a solid-state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can also be connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456, e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can include computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can include, for example, multiple processors that can include distributed processors or parallel processors in a single machine or multiple machines. Additionally, a processor can include or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can include one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can include, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, distributed node, central node, distributed training node, central unit, distributed unit, radio unit, model or AI-based model, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A method, comprising:
based on a first metric value of a metric of network activity data of a first distributed node of network nodes of a network, and a second metric value of the metric of the network activity data of a second distributed node of the network nodes of the network, identifying, by a system comprising at least one processor, at least one clustering criterion applicable to clustering respective network activity data respectively received from the network nodes of the network;
based on the at least one clustering criterion, clustering, by the system, the respective network activity data, resulting in clustered network activity data, wherein the at least one clustering criterion was selected from candidate clustering criteria based on at least one selection criterion; and
communicating, by the system to a machine learning training node, a training dataset applicable to train a machine learning model, wherein the training dataset was generated based on the clustered network activity data.

2. The method of claim 1, wherein the at least one selection criterion is based on a performance threshold applicable to an estimated clustering performance level of the at least one clustering criterion, and wherein the at least one clustering criterion was selected from the candidate clustering criteria based on the estimated clustering performance level being determined to be at least at a level corresponding to the performance threshold.

3. The method of claim 2, wherein the network was organized in accordance with an open radio access network architecture, and wherein threshold data representative of the performance threshold was received from a radio access network intelligent controller node comprised in the network.

4. The method of claim 2, wherein the estimated clustering performance level of the at least one clustering criterion was estimated by measuring the performance level of the at least one clustering criterion using a pre-defined labelled dataset.

5. The method of claim 2, wherein the estimated clustering performance level of the at least one clustering criterion was estimated based on historical network activity data received from the network nodes of the network.

6. The method of claim 2, further comprising:
estimating, by the system, the estimated clustering performance level by:
predicting an average maximum performance level of the at least one clustering criterion applicable to respective usages of the at least one clustering criterion by the network nodes, resulting in a predicted average maximum performance level; and
adjusting the predicted average maximum performance level based on a predicted overhead applicable to a quantity of the network nodes.

7. The method of claim 1, further comprising:
determining, by the system, a first statistic and a second statistic, wherein the first statistic was determined based on the first metric value and the second statistic was determined based on the second metric value, and wherein the identifying of the at least one clustering criterion comprises identifying the at least one clustering criterion based on at least a defined threshold level of similarity that characterized the first statistic and the second statistic.

8. The method of claim 7, wherein the first statistic comprises a statistical representation of raw data over a selected duration in time of the network activity data of the first distributed node.

9. The method of claim 1, wherein the first metric comprises at least one of:
a traffic load metric representative of a traffic load of first distributed node,
a temperature metric representative of a temperature of the distributed node,
a configuration metric representative of a hardware configuration of the distributed node,
a quality metric representative of a channel quality indicator measured by the distributed node,
a power metric representative of a radio frequency power of the distributed node,
an emissions metric representative of an emissions of the distributed node,
a consumption metric representative of an energy consumption of the distributed node, or
an information metric representative of channel state information of a channel employed by the distributed node.

10. The method of claim 1, wherein the training dataset communicated to the machine learning training node comprises metadata representative of at least one of:
first metadata representative of the at least one clustering criterion,
second metadata representative of the at least one selection criterion,
third metadata representative of the candidate clustering criteria,
fourth metadata representative of the first distributed node, or
fifth metadata representative of a characteristic of the first distributed node.

11. The method of claim 10, wherein the metadata is applicable to at least one of:
selection, by a model repository node, of a target node for deployment of the machine learning model, or
a period of time during which the machine learning model is prioritized for use over other machine learning models other than the machine learning model.

12. The method of claim 1, further comprising:
before the at least one clustering criterion was selected, based on analysis of the candidate clustering criteria, identifying, by the system, a coverage gap potentially resulting from use of at least one analyzed candidate criterion of the candidate clustering criteria, different from the at least one clustering criterion; and
based on the coverage gap, removing, by the system, the at least one analyzed candidate criterion from the candidate clustering criteria.

13. The method of claim 1, wherein the network was organized in accordance with an open radio access network architecture, and wherein at least one of:
the distributed node comprises a radio unit comprised in the network, or
the machine learning training node comprises a central unit comprised in the network.

14. The method of claim 1, wherein the network activity data of the first distributed node was collected in accordance with a training specification of the machine learning model, and wherein the machine learning model was tailored to account for conditions and characteristics associated with the distributed node.

15. Model repository equipment, comprising:
at least one memory that stores computer executable instructions; and
at least one processor configured to process the computer executable instructions that, when executed by the at least one processor, facilitate performance of operations, comprising:
receiving a trained artificial intelligence-based model comprising auxiliary data representative of a characteristic of operating data that was processed to generate a training dataset with which the trained artificial intelligence-based model was trained, wherein the operating data was representative of a performance of base station equipment,
based on a result of analyzing the auxiliary data, selecting a target distributed node, and
communicating the trained artificial intelligence-based model to the target distributed node.

16. The model repository equipment of claim 15, wherein the operating data comprises first operating data, and wherein the selecting of the target distributed node was based on at least one of:
first auxiliary data representative of a threshold level of similarity between second operating data of the target distributed node and the first operating data that was processed to generate the training dataset, or
second auxiliary data representative of the at least one clustering criterion applied to the target distributed node.

17. The model repository equipment of claim 15, wherein the receiving of the trained artificial intelligence-based model comprises receiving of the trained artificial intelligence-based model from model training equipment.

18. A non-transitory machine-readable medium, comprising executable instructions that, when executed by at least one processor of a network device, facilitate performance of operations, comprising:
based on an estimated performance metric of a first data grouping rule and a second data grouping rule, identifying the first data grouping rule as being applicable to grouping node-wise activity data of multiple radio unit devices of a radio access network, resulting in a selected grouping rule;
based on the selected grouping rule, grouping the node-wise activity data with a selected degree of similarity common to the multiple radio unit devices, resulting in grouped node-wise activity data; and
based on the grouped node-wise activity data, generating a training dataset applicable to training a model of operation of the multiple radio unit devices.

19. The non-transitory machine-readable medium of claim 18, wherein the operations further comprise:
based on the first data grouping rule and the selected degree of similarity, generating metadata applicable to facilitate inference operations of the model of operation by a radio unit node of the multiple radio unit devices, wherein the training dataset comprises the metadata.

20. The non-transitory machine-readable medium of claim 19, wherein the metadata is further applicable to selecting, by at least one of a model repository device or a model manager device, the radio unit node of the multiple radio unit devices.
